(19) United States
(12) Patent Application Publication
(10) Pub. No.: US 2021/0042590 A1
(43) Pub. Date: Feb. 11, 2021

(54) MACHINE LEARNING SYSTEM USING A STOCHASTIC PROCESS AND METHOD

(71) Applicant: Xochitz Watts, Mountain View, CA (US)

(72) Inventor: Xochitz Watts, Mountain View, CA (US)

(21) Appl. No.: 16/986,719

(22) Filed: Aug. 6, 2020

Related U.S. Application Data
(60) Provisional application No. 62/883,845, filed on Aug. 7, 2019.

(51) Int. Cl. G06K 9/62; G06N 7/00; G06N 3/08; G06N 20/00

(52) U.S. Cl. CPC G06K 9/6298; G06K 9/623; G06K 9/6202; G06N 20/00; G06N 7/005; G06N 3/08; G06K 9/6259

(57) ABSTRACT

A nonparametric counting process to assist with defining a cumulative probability of an in-class observation occurring by a score segment. A Markov process state space model can be applied to evaluate the stochastic process of observations over the classification model score. A new definition for the recall curve may be formulated as the cumulative probability of in-class observations being classified as in-class observations, true positives. A novel hypothesis test is provided to compare the performance of black box models. Explanations attribute a likelihood of in-class observations to feature inputs used in the black box model, even when the features are time series and in order dependent models such as recurrent neural networks. Censoring is provided to use information from the time dependence of the features and unlabeled observations to derive global and local explanations.

### CROSS-REFERENCE TO RELATED APPLICATION

This application claims the priority from U.S. provisional patent application Ser. No. 62/883,845 filed Aug. 7, 2019. The foregoing application is incorporated in its entirety herein by reference.

### FIELD OF THE INVENTION

The present disclosure relates to a machine learning system using a stochastic process. More particularly, the disclosure relates to analyzing machine learning approaches using a stochastic process and/or other processes and providing a visual representation of same.

### BACKGROUND

Artificial intelligence and, more particularly, machine learning techniques used in artificial intelligence, are becoming increasingly common in our everyday lives and workflows. Machine learning allows an operation to analyze substantial quantities of data included in a dataset to detect patterns. These patterns may be analyzed to indicate likely outcomes given stimuli based on the data. Although the recognize patterns may not be absolute, the information the predictions can provide are often helpful for a wide range of applications. Machine learning environments typically suggest a theory to explain observed facts, unlike traditional computer analytic operations that draw conclusions from mathematical operations.

Often in machine learning environments, instructions for how to initially analyze data are programmed into a computerized device for a given task. The machine learning system may use multiple iterations of this analysis to continually interpret data and improve on those interpretations. The data is often initially provided as one or more datasets that can be used to train the machine learning system. The machine learning system may then make predictions based on the data, which can be validated to determine their efficacy. Predictions with higher levels of efficacy maybe positively weighted to increase the likelihood of future predictions following this trend. Predictions with lower levels of efficacy may be negatively weighted to reduce the likelihood of future predictions following those trends. This process may be repeated over multiple generations until the predictive ability of the machine learning system reaches an acceptable level.

However, limitations of this black box approach traditionally obscure how predictions by the machine learning system are determined and how weights are assigned throughout the generations. Often, operators of a machine learning system are left to guess how such a machine learning system is operating between the point of receiving the data and producing results. No known solution existing in the current state-of-the-art can explain the effect of variables upon the probability of responses of the black box model machine learning system. Additionally, no known solution exists in the state-of-the-art that can score an output from the black box model to be visualized and presented to an operator with an indication of how that output was derived.

Classification is a type of supervised machine learning problem that predicts the class of given observations. Classes are also known as labels, categories, or targets. The classification model maps input variables or features to discrete output variables. Many of the statistical problems in business are classification problems, illustratively image recognition labels objects in an image, the financial industry determines if a person should receive a loan, and the advertising technology industry discovers individuals who would act on an advertisement. Classification tasks find rules that explain how to separate observations into different categories. The feature values or attributes of the observations are used to determine the rules in finding the decision boundary that separates the classes. Challenges exist in the current state of the art to determine if a classification algorithm is superior to another because the model performance depends on the domain and the nature of feature data. Some features are categorical, others continuous, and still others are time series data.

Researchers have shared machine learning artifacts and benchmark systems to select a correct model and model parameters. Machine learning models were benchmarked based on their performance to explain the machine learning model prediction for a given application. Model explanations justify a model outcome and provide insight into the feature characteristics of the observations. Illustratively, they describe the importance of the features in forming a decision boundary, positive or negative impact of the feature to assign an observation to a class, and correlation between features used in the machine learning model. The relevance of classification models in business statistical problems popularized explanations of classification problems.

Classification problems are believed to occur in substantially all industries, illustratively technology, healthcare, finance, investment, manufacturing, marketing, and retail. Advertising technology uses explanations for algorithmic accountability due to the laws and regulations, such as General Data Protection Regulation (GDPR), giving citizens of the European Union with a right to an explanation from machine learning models.

In advertising technology, one use of machine learning is to predict whether a household would buy the product being advertised, which determines whether the individuals in the household are shown a targeted advertisement. The machine learning model learns the behavior of a household and assigns it a score that represents the confidence for the household to purchase the product. Explanations of the model offer a reason for the model to predict that a household would purchase the product, including which attributes of the household led to the classification.

Along with a general explanation of the classification score for all the observations, advertisers look for local explanations that describe the attributes of households in a score neighborhood to find shared attributes among households with a similar score. An explanation of the model in a score neighborhood is known as a local explanation. In the industry, both regulation such as GDPR and the expectation to be accountable to retailers drive a need for explanations of the model score. This is only one of many examples that can be used to frame explanations of classification models in industry applications.

Additionally, Explainable Artificial Intelligence (XAI) has led to Responsible Artificial Intelligence, a methodology for the large-scale implementation of AI methods in real organizations with fairness, model explainability, and accountability. According to the Defense Advanced Research Projects Agency (DARPA), XAI aims to “produce more explainable models, while maintaining a high level of learning performance (prediction accuracy); and enable human users to understand, appropriately trust, and effectively manage the emerging generation of artificially intelligent partners.”

Not all machine learning models require explanations. Some models have the ability to be interpreted by the degree to which the model can be simulated, decomposed to consumable parts, and transparent in making a decision with unambiguous instructions or algorithms. The research community has various taxonomies and definitions for explanations and interpretations. Some differentiate between the terms, and others use them interchangeably. XAI has applications in all fields that use artificial intelligence, particularly critical systems in aerospace, space, ground transportation, defense, security, and medicine.

Explanations help detect and correct bias in the training data, enable robustness by highlighting potential adversarial perturbations that could change the prediction, and assess the underlying causality that exists in model reasoning. Explanations describe the decision made by a machine learning model in order to gain user acceptance and trust, support laws based on ethical standards and the right to be informed about the basis of the decision, debug the machine learning system to identify flaws and inadequacies, or identify distributional drift. Explanations are used to explore the data, confide in a working system, establish fairness and highlight bias, access the process of machine learning models, improve the ability to tweak and interact with the models to ensure success, and design data protection and privacy awareness into the algorithms to make them responsible, explicable, and human-centered. Not every explanation method in the current state of the art is capable of satisfying all goals for XAI. Some methods are more suited for particular data structures or motivations to explain. It is believed that the current state of the art lacks a general method of explanation for machine learning classification models including time series classification models.

Therefore, a need exists to solve the deficiencies present in the prior art. What is needed is a system and method for applying machine learning models to observations in a dataset. What is needed is a system and method for determining relevancy of observations in a machine learning dataset. What is needed is a system and method for predicting relevant instances to machine learning model decisions. What is needed is a system and method for predicting relevance of instances at machine learning model decision events. What is needed is a system and method for determining a score threshold of a model based on relevance of features to a machine learning model decision at different score thresholds. What is needed is a system and method for visualizing predicted observations to characterize an environment at final and/or latest timesteps indicative of relevance of observations at prior times steps.

### SUMMARY

An aspect of the disclosure advantageously provides a system and method for applying machine learning models to observations in a dataset. An aspect of the disclosure advantageously provides a system and method for determining relevancy of observations in a machine learning dataset. An aspect of the disclosure advantageously provides a system and method for predicting relevant instances to machine learning model decisions. An aspect of the disclosure advantageously provides a system and method for predicting relevance of instances at machine learning model decision events. An aspect of the disclosure advantageously provides a system and method for determining a score threshold of a model based on relevance of features to a machine learning model decision at different score thresholds. An aspect of the disclosure advantageously provides a system and method for visualizing predicted observations to characterize an environment at final and/or latest timesteps indicative of relevance of observations at prior times steps. A system and method enabled by this disclosure advantageously provides a general method of explanation for machine learning classification models including time series classification models.

At least one aspect of this disclosure may enable predictive analytics regarding a machine learning operation, which may include providing insight into how a decision is produced from a black box model machine learning operation. Illustratively, local score dependent explanations may be provided for time series data used in binary classification machine learning systems. These systems may offer model explanations which are inclusive of the underlying data structure. The following disclosure provides the first known modeling of a machine learning output as a stochastic process rather than being deterministic. A system, method, or technique enable by this disclosure may give global explanations of the model by attributing a multiplicative factor and/or a local explanation of the model by attributing an additive factor locally to observations with similar scores. A variation of the Markov process; a multiplicative hazards model, for example, as a proportional hazards regression model; a generalized additive model, and/or other models may be used to explain the effect of variables upon the probability of an in-class response for a score output from the black box model. Covariates may incorporate time dependence structure in the features.

The present disclosure provides an approach for extending the state of the art in explanations of time series classification models. Explanations of time series models are difficult to retrieve because the data is structured with time as an additional dimension. Therefore, methods to explain classification models that use time dependent data are more restricted than for other classification models. Most methods cannot integrate a third dimension in the explanation, so current methods are restricted to visualizing deep neural network unit activation. Approaches of stochastic processes described throughout this disclosure add to the state of the art by representing historical values in the time series as censored observations. The present disclosure explains a concept of censorship, where censored observations inform how discrete output variables map over the score of the machine learning model. An approach provided by this disclosure is validated in an illustrative trial performed on time series hard drive failure data.

It is believed that the this disclosure describes work that provides the first time the model score and in-class observations have been proven to be a Markov process state space model and the explanations incorporate time dependent data for global explanations and score dependent local explanations.

The disclosure begins the analysis using the product limit estimator to derive a nonparametric statistic used to estimate the cumulative probability of an observation being a true in-class observation over the black box model score. The product limit estimator may also be named as the probability of inclusion, which is identical or substantially identical to the recall curve of the model.

The approach described throughout this disclosure introduces a model comparison hypothesis test, illustratively, the logrank hypothesis test, to compare the efficacy of different black box machine learning models. An explanation approach enabled by this disclosure may use a semi-parametric model, proportional hazards (PH) regression model, on the cumulative probability curve to explain the hazard rate of in-class observations over the model score with features used to train the model.

The approach may be extended to incorporate time series covariates and score dependent coefficients with a generalized additive model (GAM). The application described throughout this disclosure can be applied generally, such as where the features used in the black box model have a causal relationship to the classification label.

This disclosure provides theoretical justification and experimental evidence for time series data explanation. Although the disclosure explains illustrative applications using the black-box model without diminishing the complexity, it may be limited in explaining data sets due to the curse of dimensionality where a data set requires more true positive observations than the number of covariates used in the explanation.

Accordingly, the disclosure may feature a system for offering an explanation using a stochastic process, which may in some cases incorporate time dependent data, in machine learning operations including a product limit estimator, a hypothesis test, a multiplicative hazards model, a general additive model, and/or additional models or operations. The product limit estimator may analyze a data set and derive a nonparametric statistic indicative of a probability of occurrence of an in-class observation at a model score. The hypothesis test may compare an efficacy of the product limit estimator operated with the data set using varied parameters. The multiplicative hazards model may prepare the explanation for the model score relating to the in-class observation regarding a baseline hazard rate at score intervals. The generalized additive model may determine a causal relationship between covariates and coefficients dependent of the model score. Sequence data, categorical data, and/or continuous data may be regarded as inputs to an uninterpretable machine learning classification model, for example, including a recurrent neural network. At least part of the data set may be ordered using time, for example, as an index via the stochastic process.

In another aspect, the nonparametric statistic may be used for estimating a cumulative probability of an observation being the in-class observation over a black box model score provided by a black box model.

In another aspect, the nonparametric statistic may be approximately identical to a recall curve of the black box model.

In another aspect, the system may further include point censoring to assist the product limit estimator by providing monitoring of the model score over a score set comprising missing event data.

In another aspect, the hypothesis test may use a semi-parametric model to explain a hazard rate of the in-class observations compared with the black box model score.

In another aspect, the hazard rate may be included by the explanation, for example, via the multiplicative hazards model.

In another aspect, comparison of the in-class observations with the black box model score may relate to features used to train the black box model. The multiplicative hazards model may include a proportional hazards regression model.

In another aspect, the uninterpretable machine learning classification model may include a recurrent neural network. In some embodiments, the recurrent neural network may further include a long short-term memory network.

In another aspect, the long short-term memory network may include nonlinear deep connected layers that are at least partially uninterpretable.

In another aspect, the proportional hazards regression model may analyze input variables via a Markov model.

In another aspect, the Markov model may be trained after the recurrent neural network to provide weights that assist in interpreting an output of the recurrent neural network.

In another aspect, the hypothesis test may include a logrank hypothesis test.

In another aspect, the covariates analyzed by the generalized additive model may be time variable covariates. The baseline hazard rate may be additionally compared to the coefficients.

Accordingly, in another embodiment, the disclosure may feature a system for offering an explanation using a stochastic process in machine learning operations including a product limit estimator, a logrank hypothesis test, a proportional hazards regression model, a generalized additive model, point censoring, and/or other models or operations. The product limit estimator may analyze a data set and derive a nonparametric statistic used for estimating a cumulative probability of an observation being an in-class observation over a black box model score provided by a black box model. The logrank hypothesis test may compare an efficacy of the product limit estimator operated with the data set using varied parameters. The proportional hazards regression model may prepare the explanation for the model score relating to the in-class observation regarding a baseline hazard rate at score intervals. The generalized additive model may determine a causal relationship between covariates and coefficients dependent of the model score. The point censoring may assist the product limit estimator without introducing bias by providing monitoring of the model score over a score set comprising missing event data. Sequence data, categorical data, and/or continuous data may be regarded as inputs to an uninterpretable machine learning classification model, for example, a recurrent neural network. At least part of the data set may be ordered using time as an index via the stochastic process. Comparison of the in-class observations with the black box model score may relate to features used to train the black box model.

In another aspect, the uninterpretable machine learning classification model may include nonlinear deep connected layers that are at least partially uninterpretable.

In another aspect, the proportional hazards regression model may analyze input variables via a Markov model trained concurrently with the recurrent neural network to provide weights that assist in interpreting an output of the recurrent neural network.

Accordingly, the disclosure may feature a method of offering an explanation using a stochastic process in machine learning operations. The method may be performed on a computerized device comprising a processor and memory with instructions being stored in the memory and operated from the memory to transform data. The method may also include analyzing a data set via a product limit estimator. Additionally, the method may include deriving a nonparametric statistic via the product limit estimator indicative of a probability of occurrence of an in-class observation at a model score. The method may include comparing via a hypothesis test an efficacy of the product limit estimator operated with the data set using varied parameters. Furthermore, the method may include preparing via a multiplicative hazards model the explanation for the model score relating to the in-class observation regarding a baseline hazard rate at score intervals. In addition, the method may include determining via a generalized additive model a causal relationship between covariates and coefficients dependent of the model score. Sequence data, categorical data, and/or continuous data may be regarded as inputs to an uninterpretable machine learning classification model, for example, a recurrent neural network. At least part of the data set may be ordered using time as an index via the stochastic process.

In another aspect, the method may include assisting the product limit estimator via point censoring by providing monitoring of the model score over a score set comprising missing event data without introducing bias.

In another aspect, the method may include analyzing input variables via the proportional hazards regression model using a Markov model trained after operating the uninterpretable machine learning classification model the recurrent neural network to provide weights that assist in interpreting an output of the recurrent neural network.

In another aspect, the nonparametric statistic may be used for estimating a cumulative probability of an observation being the in-class observation over a black box model score provided by a black box model that is approximately identical to a recall curve of the black box model.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative system enabled by this disclosure, according to an embodiment of this disclosure.

FIG. 2 is a flowchart view of an illustrative operation performable by an example system, according to an embodiment of this disclosure.

FIG. 3 is a chart view of illustrative results indicating a probability of inclusion, according to an embodiment of this disclosure.

FIG. 4 is a chart view of illustrative beta values regarding Schoenfeld residuals for an example normalized SMART 187 dataset, according to an embodiment of this disclosure.

FIG. 5 is a chart view of illustrative beta values regarding Schoenfeld residuals for an example normalized SMART 198 dataset, according to an embodiment of this disclosure.

FIG. 6 is a chart view of illustrative beta values regarding Schoenfeld residuals for an example raw SMART 193 dataset, according to an embodiment of this disclosure.

FIG. 7 is a chart view of illustrative intercept scores relative to cumulative coefficients, according to an embodiment of this disclosure.

FIG. 8 is a chart view of illustrative scores relative to cumulative coefficients for a normalized SMART 187 dataset, according to an embodiment of this disclosure.

FIG. 9 is a chart view of illustrative scores relative to cumulative coefficients for a normalized SMART 198 dataset, according to an embodiment of this disclosure.

FIG. 10 is a chart view of illustrative scores relative to cumulative coefficients for a raw SMART 193 dataset, according to an embodiment of this disclosure.

FIG. 11 is a chart view of illustrative sensitivity metrics for various raw and normalized SMART datasets, according to an embodiment of this disclosure.

FIG. 12 is a chart view of illustrative proportional hazards coefficient metrics for various raw and normalized SMART datasets, according to an embodiment of this disclosure.

FIG. 13 is a chart view of an illustrative X-Y plot relating to factor (y) for various prototype models, according to an embodiment of this disclosure.

FIG. 14 is a chart view of an illustrative normal distribution having no difference in mean for probability of inclusion vs score, according to an embodiment of this disclosure.

FIG. 15 is a chart view of an illustrative normal distribution having a 0.2 difference in mean for probability of inclusion vs score, according to an embodiment of this disclosure.

FIG. 16 is a chart view of an illustrative beta distribution having no difference in mean for probability of inclusion vs score, according to an embodiment of this disclosure.

FIG. 17 is a chart view of an illustrative beta distribution having a 0.2 difference in mean for probability of inclusion vs score, according to an embodiment of this disclosure.

FIG. 18 is a block diagram view of an illustrative computerized device, according to an embodiment of this disclosure.

### DETAILED DESCRIPTION

The following disclosure is provided to describe various embodiments of a machine learning system using a stochastic process. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term explanation, as it is used throughout this disclosure, is defined as a suggested theory based on observed facts from data. The term example, as it is used throughout this disclosure in the context of an operation or analysis relating to a machine learning operation, is defined as a row of a dataset, which may include a feature and/or a label. The term dataset, as it is used throughout this disclosure, is defined as a collection of examples. The term segment, as it is used throughout this disclosure, is defined as divided parts of datasets. The term observation, as it is used throughout this disclosure, is defined as a data point, row, and/or sample in a dataset. Skilled artisans will appreciate an observation may be alternatively referred to as an instance throughout this disclosure, without limitation. The term score or scoring, as it is used throughout this disclosure, is defined as a component of a recommendation system that may provide value or ranking for candidate items. The term feature, as it is used throughout this disclosure in the context of an operation or analysis relating to a machine learning operation, is defined as an input variable to assist with making predictions. The term responder, as it is used throughout this disclosure, is defined as an observation in the class modeled.

Various aspects of the present disclosure will now be described in detail, without limitation. In the following disclosure, a machine learning system using a stochastic process will be discussed. Those of skill in the art will appreciate alternative labeling of the machine learning system using a stochastic process as a machine learning observation analysis system, machine learning visualization system, machine learning explanation system, score display system, stochastic application for transparent explanation of classification models, the invention, or other similar names. Similarly, those of skill in the art will appreciate alternative labeling of the machine learning system using a stochastic process as a score explanation method, machine learning observation method, method for analyzing machine learning operations, stochastic process for transparent explanation of classification models, method, operation, the invention, or other similar names. Skilled readers should not view the inclusion of any alternative labels as limiting in any way.

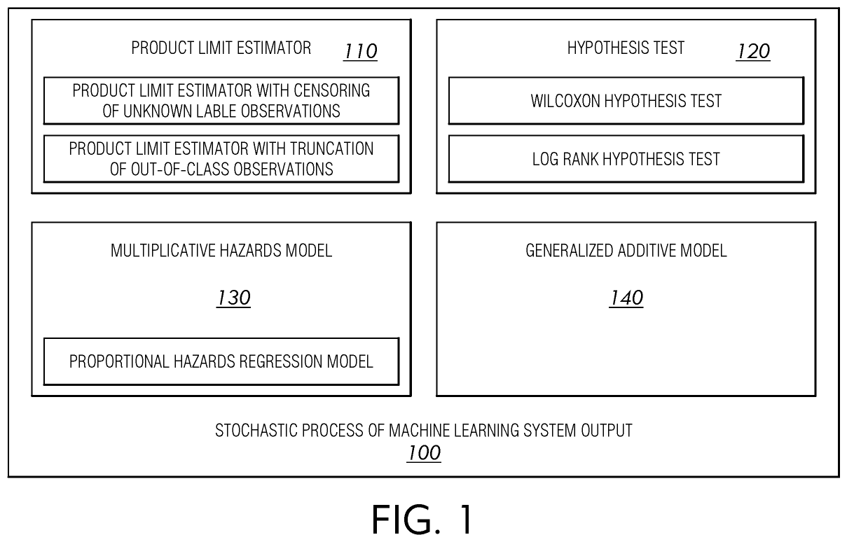

Referring now to FIGS. 1-18, the machine learning system using a stochastic process will now be discussed in more detail. The machine learning system 100 may use a stochastic process to model the machine learning system output. The stochastic process and method may be stored in computer memory. The machine learning system 100 may include a product limit estimator 110, hypothesis test 120, multiplicative hazards model 130, generalized additive model 140, censoring, training component, visualization component, and additional components that will be discussed in greater detail below. The machine learning system using a stochastic process may operate one or more of these components interactively with other components for analyzing machine learning approaches using a stochastic process and/or other processes and providing a visual representation of same.

Machine learning is generally considered a field of artificial intelligence. One of the advantages of using machine learning is the ability to quickly predict patterns and predict the statistical probability of such patterns producing an outcome. Illustratively, machine learning operations may advantageously analyze large sets of data from which it may extract and use valuable information.

Machine learning models may be broadly used for classification problems. Illustratively, deep neural networks may be commonly used with machine learning operations to realize high predictive accuracy. However, using a machine learning approach in a predictive model may rely on opaque classifiers. For the purposes of this disclosure, a classifier is defined as a tool utilizing training data to deduce how input data relates to a class. With sufficient training, a classifier may substantially accurately determine a statistically probable outcome based on recognized patterns in the data received. Classifiers can be consider opaque when the decisions between receiving the data and outputting the probable result is obscured by the machine learning process. A system and method enabled by this disclosure may advantageously explain a model decision caused by the feature inputs. In one embodiment, a system and method enabled by this disclosure may be applied to operations relating to features from a time series data model and/or example black box models for uninterpretable machine learning classification models, for example, recurrent neural networks.

Explainable machine learning aims to make clear the decision for the predicted outcome of any machine learning model, ideally with no performance loss. Post-hoc methods may explain black box classification models without any additional burden on the architecture or performance of the model. A novel technique provided by this disclosure is a stochastic process application to the machine learning model output. The stochastic process is on the score to event data where the event is an in-class observation. Using this framework, this disclosure enables finding the probability distribution definition of recall and a new hypothesis test for comparing recall curves. In this disclosure, a post-hoc model explanation is provided to determine how the classification model behaved through global explanations for the entire decision space as well as local explanations for observations within a region of the model score output.

This framework also advantageously enables performance of global and local regression models on the output of the machine learning model to explain the hazard rate of in-class observations, the propensity of an observation to be in-class over the model score. The coefficients of the regression explain why the observation received the black box classification score. Experimentation was performed on time series hard drive reliability statistics data to predict hard drive failure using a long short-term memory deep neural network, although the method can be applied to any classification model, which will be discussed later in the disclosure.

An example using a time series classification will now be discussed, without limitation. In this example, an explanation of time series classification may be differentiated because the attributes may be ordered. While there has been no formal or technical agreed upon definition of model explanations, explanations for machine learning models enabled by this disclosure may provide an account that makes the model classification decision clearer. For the purpose of this disclosure, explanations describe a decision made by a machine learning model system and method to gain user acceptance and trust. Explanations may additionally be beneficial in the context of compliance with ethical standards, the right to be informed about the basis of the decision, debugging the machine learning system to identify flaws and inadequacies and/or distributional drift, for increase insight to a domain area, for instance uncovering causality, and other purposes that would be apparent to a person of skill in the art after having the benefit of this disclosure. A post hoc model explanation may be produced to determine how and why the classification model behaved through global explanations for the decision space, as well as local explanations for observations within a region of the model score output.

Aspects included in this disclosure feature a novel, first-time application to analyze a model score and response using a stochastic analysis process, such as a Markov process state space model, and the explanation that may include time dependent data for global explanations and score dependent explanations. A novel feature may provide analysis using the product limit estimator to derive a non-parametric statistic used to estimate the cumulative probability of an observation being a true responder over the black box model score. The explanation method then may use a semi-parametric model, such as a proportional hazards (PH) regression model on the cumulative probability curve to explain the model scores using the model attributes.

The explanations may be extended to incorporate time dependent covariates and score dependent coefficients with a generalized additive model (GAM). In at least one embodiment, a system and method enabled by this disclosure can be applied generally where the features used in the black box model have a causal relationship to the classification label. To help clarify this aspect, experimental evidence is provided below for an embodiment featuring time series data to use multiplicative hazards model, for example and without limitation, a proportional hazards regression model, as an explanation but are not intended to limit the disclosure to the specific example of explaining certain models and datasets.

In the interest of clarity, recurrent neural networks (RNN) that may be used in with one or more systems and methods enabled by this disclosure will now be discussed, without limitation. RNNs are typically a black box model inherently unclear as to how a decision output is produced from input data. Long short-term memory (LSTM) cells may be used for sequences of data to be processed. A LSTM network may be a type of RNN model that uses sequence data as inputs. Skilled artisans will appreciate various within the scope and spirit of this disclosure to regard sequence data, categorical data, and/or continuous data as inputs to an uninterpretable machine learning classification model. LSTM cells may keep a hidden state over the series in the sequence. Illustratively, a LSTM cell may use gating mechanisms to read from, write to, or reset the cell. LSTM is traditionally well-suited for classifying time series data and mitigating a vanishing gradient problem inherent to RNNs. The RNN may learn a dense black-box hidden representation of the sequential input and classify time series data using this representation. While a classical deep neural network does not use sequential information, LSTM layers have nonlinear internal states which are unexplainable by traditional techniques in the current state of the art.

A LSTM network that can be analyzed by a system and method enabled by this disclosure may advantageously include nonlinear deep fully connected layers which are unexplainable hidden layers. These techniques improve on prior methods to explain RNNs, which typically rely on sensitivity analysis and deep Taylor decomposition.

Illustratively, layer-wise relevance propagation assigns a relevance score to the neural network cells rather than assigning relevance to the inputs. Current known explanation methods in the art explain the architecture and structure of a neural network but lack additional insight. A system and method enabled by this disclosure may provide additional explanations using the stochastic process described throughout this disclosure. The current state of the art is believed to lack research for deep Taylor decomposition heatmaps for LSTM networks and time series data, where the method is mostly used on convolutional neural networks. This disclosure provides a system and method that is believed to be the first technique for time dependent inputs to receive explanations with score dependent coefficients.

Foundational information will now be discussed, without limitation. An assumption of an underlying Markov process and methods developed in the field of Survival Analysis may be used to gain insight into a machine learning operation, such as relating to a black-box model. A stochastic counting process may be used to derive a product limit estimator, which may derive a non-parametric statistic used to estimate the cumulative probability of an observation being a true responder over the black box model score.

In one embodiment, provided without limitation, a state space of an observation in a binary classification model may have a cardinality of three. The state space may be a responder, a nonresponder, or unknown response. For the purpose of this disclosure, a responder is an observation in the class modeled. For the purpose of this disclosure, a nonresponder is out of the class. For the purpose of this disclosure, an unknown response is censored where the value of the observation is only partially known, or it is an unlabeled observation. For the purpose of this disclosure, a stochastic process includes an observation moving from the nonresponder state to a responder state. An individual observation may move from one state to another state by observation factors used as inputs to a black box classification, permitting use of a model where evidence of cause and effect exists.

Furthermore, nonresponders may be truncated from the analysis if a state is absorbing where it cannot go from a nonresponder to a responder given virtually any feature set, excluding it from the stochastic process. Unlabeled observations may provide some information with the model score output and may be incorporated as censored data.

Time series and various applications of systems and methods enabled by this disclosure to same will now be discussed. Many XAI methods are not applicable to time dependent or sequence data. For instance, sequence data may have an ordered multi-dimensional structure and cannot be used with popular XAI methods. With the limitations in methods considering the data structure of RNNs, few methods currently exist to explain recurrent neural networks or other uninterpretable machine learning classification models. Available methods can be divided into two groups, the first set of explanations find feature relevance and the second modifies the RNN architecture so the algorithm is transparent. Skilled artisans will appreciate sequence data, categorical data, and/or continuous data may be regarded as inputs to an uninterpretable machine learning classification model.

An illustrative embodiment of the product limit estimator 110 as shown in FIG. 1 and related operations will now be discussed, without limitation. The probability of inclusion estimator is a nonparametric statistic used to measure the recall at model score s, the fraction of in-class observations in the data with a model score S greater than s. Without censoring, the probability of inclusion estimator may estimate the complement of the empirical distribution. The probability of inclusion estimator is also known as the product limit estimator because it involves computing probabilities of occurrence of in-class observations at a certain score s and multiplying these successive probabilities by earlier computed probabilities to get the final estimate.

Each observation may be given a score output for the confidence of the observation to be in-class from the machine learning model. Scores from the classifier offer a ranking for which an observation i is likely to be included as in-class for category k. The score S is an output from a machine learning model and can be interpreted as a probability or a utility for assigning an observation i to category k. Each observation may be either an in-class observation, out-of-class observation, or an unlabeled censored observation having a score given to the observation as a random variable.

A probability of inclusion curve may be calculated using the performance of the model for different score cutoffs, similar to calculating recall at various score cutoffs.

The probability of inclusion curve uses order statistics from the score output file, where at each interval a confusion matrix summarizes the output of the model. The interval size can vary to be of equal length or calculated with each additional observation.

Using statistics from the confusion matrices, the product limit estimator may form the probability of inclusion, which may construct the recall curve. The product limit estimator may be the maximum likelihood of the cumulative distribution function (CDF) of the probability of inclusion when only in-class observations are considered in the analysis. The cumulative distribution function of the probability of inclusion is considered nonidentifiable, or more than one distribution function of S may exist that may be compatible with the data, when censored observations are included. The probability of inclusion is the conditional probability of being in-class at a score segment j given the in-class observation had a score greater than s, the score at segment j.

An illustrative embodiment of the hypothesis test 120 as shown in FIG. 1 and related operations will now be discussed, without limitation. A researcher may develop multiple models from the same dataset by changing parameters, introducing new features using feature engineering, or using different algorithms to build models. The researcher may also compare the output performance of the models and select the model that best fits the domain purpose. For example, the hypothesis test may use a semi-parametric model to compare the probability of inclusion derived from black box model scores.

In one embodiment, hypotheses may be tested using these varied parameters. Illustratively, logrank and Wilcoxon tests may be used as hypothesis testing methods for comparing two or more probability of inclusion curves I_{g}(s) where some of the observations may be censored and the overall grouping may be stratified or contain multiclass classification.

Illustratively, a null hypothesis may state that I₁(s)=I₂(s)==I_{g}(s) for all s. The alternative is that at least one I₁(s) is different for some s. The logrank hypothesis test may have loss of power if the proportional hazards assumption is not met. However, the Wilcoxon test is nonparametric and does not make assumptions about the distributions of the probability of inclusion estimates. In some embodiments that include a logrank hypothesis test, the Wilcoxon test or another hypothesis test may supplement and/or replace the logrank hypothesis test.

In an alternative embodiment, explainability of the effects of the model covariates can be approximated through a Cox Proportional Hazards (CPH) regression model. In this embodiment, the regression ideally predicts a distribution of the score to response from a set of covariates. For the purpose of this disclosure, covariates can be binary categorical or continuous and can be time dependent. Time dependent features may be incorporated as additional observations in the data with a censored response. The theoretical derivation remains the same as discussed throughout this disclosure.

The proportional hazard regression model 130 as shown in FIG. 1 will now be discussed in greater detail. Skilled artisans will appreciate that the following discussion of a proportional hazard regression model is provided as an illustrative model and is not intended to limit the scope of the disclosure. In this illustrative proportional hazard regression model, explanations of the black box classification model can be found using the input variables as covariates. The proportional hazard regression model may advantageously explain scores of the in-class observations via the covariates.

In one embodiment, a multiplicative hazards model may quantify a relationship between the black box model score sᵢ and a set of explanatory variables, illustratively, given that the observation did not have a black box model score lower than sᵢ. Potential explanatory variables, or the covariates, may be the input variables used to train the classification model.

This explanatory model may find an effect of the explanatory variables on an underlying baseline hazard rate. For the purpose of this disclosure, a baseline hazard rate is a hazard rate of an observation when all covariates are equal to zero. The effect of the covariates can act with a multiplicative factor on the baseline hazard.

Additionally, a coefficient may be provided for each feature. The coefficient may be a change in an expected log of the hazard ratio relative to a change in the feature, such as a one-unit change in the feature, holding all other predictors constant. In proportional hazard regression, an assumption can be made that the effect of the covariate on the baseline hazard is proportional over the model score. In some applications, explanatory variables may change their values over time and should be used with caution.

According to an embodiment of this disclosure, an adaptation of a Markov model as it applies the analysis will now be discussed, without limitation. As will be appreciated by those of skill in the art, the Markov model is a stochastic model to describe a sequence of possible events with varying probabilities of occurrence determined by the state attained in prior events. The Markov model may be used with a Martingale process to further understand obscured decisions. As will be appreciated by those of skill in the art, the Martingale process is a stochastic process having a sequence of random variables such that an expected value of the next value, being conditional on the current value, is the current value.

To this effect, the Markov model may provide a convenient and intuitive tool for constructing hazard models for a response to occur at a certain score interval. The Markov process and the Martingale process may simplify a dependence structure of a stochastic process. As discussed above, the stochastic process is an observation changing from a nonresponder to a responder over an indexed value of a model score. For the purpose of this disclosure, the index set used to index a random variable in this adaptation may be the score output from a binary classification model, rather than using time in survival analysis or traditional Markov processes as the index set. Model score is an ordered sequence and is analogous to time. Concepts of a past and a future is defined in terms of lower or higher score.

The Markov definition is a simplification of the transition probabilities that describe the probability for the process to move from one state to another within a specified score interval. A Markov process is traditionally memoryless. Once the current state of the process is known, knowledge of the past or virtually any circumstance in which an observation receives a lesser score does not give further information about the state of the process in the future or, in this case, a higher score. Then, a current state can describe the probability distribution of the process over the score interval.

As discussed above, the random process of responder observations over the model score can be modeled as a Markov process. The Markov model describes the risk process of a responder observation at a score outputted from a black box classification model. Theory and illustrative applicability of the Markov model will be discussed later in this disclosure, without limitation.

Explanations of the black box classification model can be found using the input variables as covariates in a proportional hazards regression model to explain the scores of the in-class observations. The multiplicative hazards model quantifies the relationship between the black box model score sᵢ stand a set of explanatory variables given that the observation did not have a score lower than sᵢ. The potential explanatory variables or covariates are the input variables used to train the classification model.

The explanatory model can be used to find the effect of the explanatory variables on the underlying baseline hazard rate, which is the hazard rate of an observation when all covariates are equal to zero. The effect of the covariates may act with a multiplicative factor on the baseline hazard. The coefficient for each feature is the change in expected log of the hazard ratio relative to a one-unit change in the feature, holding all other predictors constant. In proportional hazards regression the assumption is that the effect of the covariate on the baseline hazard is proportional over the model score. The explanatory variables may change their values over time and should be used with caution.

The generalized additive model 140 as shown in FIG. 1 will now be discussed in greater detail. As will be appreciated by those of skill in the art, a generalized additive model (GAM) advantageously shares features from a generalized linear model and an additive model to determine an inference for unknown smooth functions. In one embodiment, explanations relating to the black box classification model may be extended using score dependent coefficients in a generalized additive model.

In one embodiment including a generalized additive model, the baseline hazard rate and the covariate effects in the additive model may be dependent on the score given across observations over time. Covariates may also be time dependent, such as may occur for recurrent neural networks and time series data. Inclusion of the generalized additive model may be advantageous when the proportional hazards assumption is not met and the explanation is local to a score neighborhood, as will be appreciated by those of skill in the art. In one illustrative scenario in which a generalized additive model may be beneficial, a covariate may have a large effect in the first segments of the model score, but the effect may disappear or switch signs in later segments.

The coefficients in the generalized additive model may be interpreted as excess risk or a risk difference at a score j for the corresponding covariate, rather than the risk ratio as in the proportional hazards model. The effects of the covariates may change over score and may be arbitrary regression functions. In one embodiment, the function used may be ordinary linear regression and may be estimated through the cumulative regression functions, as shown below in Equation 1.

B_{q}(s)=∫₀^{s}Bq(u)du Equation 1

The estimations are the derivatives from the cumulative regression function, making the slopes of the plots informative. Stability in the estimates may be achieved by aggregating the increments over the score because any single regression poorly fits the increments, as shown below in Equation 2.

dB_{q}(s)=B_{q}(s)ds Equation 2

The training component will now be discussed in greater detail. The training component may optionally be included, and may advantageously assist a system and method enabled by this disclosure to analyze a volume of data to familiarize itself with the datatypes on which analysis will be performed and begin detecting patterns that may be used to predict an output, such as an explanation.

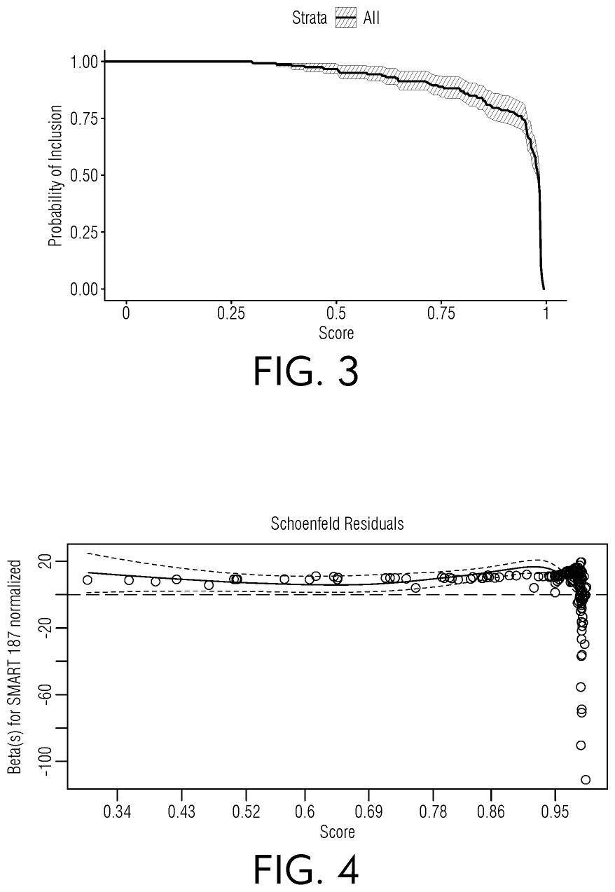

The visualization component will now be discussed in greater detail. The visualization component may optionally be included and may advantageously provide visual references indicative of the operations performed and normally obscured by the black box model of machine learning operations. Examples of visual references may include values in alphanumerical formats, mathematical formulae, graphs, charts, interactive interfaces, sound, and/or other audiovisual content. Illustrative visual references are provided in FIGS. 3-17, without limitation. These illustrative visual references are discussed in context with the example evaluation provided throughout this disclosure.

Referring now to FIG. 18, an illustrative computerized device will be discussed, without limitation. Various aspects and functions described in accord with the present disclosure may be implemented as hardware or software on one or more illustrative computerized devices 1800 or other computerized devices. There are many examples of illustrative computerized devices 1800 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 1800 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 1800, among others. Additionally, aspects in accord with the present disclosure may be located on a single illustrative computerized device 1800 or may be distributed among one or more illustrative computerized devices 1800 connected to one or more communication networks.

Illustratively, various aspects and functions may be distributed among one or more illustrative computerized devices 1800 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 18 shows a block diagram of an illustrative computerized device 1800, in which various aspects and functions in accord with the present disclosure may be practiced. The illustrative computerized device 1800 may include one or more illustrative computerized devices 1800. The illustrative computerized devices 1800 included by the illustrative computerized device may be interconnected by, and may exchange data through, a communication network 1808. Data may be communicated via the illustrative computerized device using a wireless and/or wired network connection.

Network 1808 may include any communication network through which illustrative computerized devices 1800 may exchange data. To exchange data via network 1808, systems and/or components of the illustrative computerized device 1800 and the network 1808 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 1800 may transmit data via the network 1808 using a variety of security measures including TSL, SSL, or VPN, among other security techniques. The illustrative computerized device 1800 may include any number of illustrative computerized devices 1800 and/or components, which may be networked using virtually any medium and communication protocol or combination of protocols.

Various aspects and functions in accord with the present disclosure may be implemented as specialized hardware or software executing in one or more illustrative computerized devices 1800, including an illustrative computerized device 1800 shown in FIG. 18. As depicted, the illustrative computerized device 1800 may include a processor 1810, memory 1812, a bus 1814 or other internal communication system, an input/output (I/O) interface 1816, a storage system 1818, and/or a network communication device 1820. Additional devices 1822 may be selectively connected to the computerized device via the bus 1814. Processor 1810, which may include one or more microprocessors or other types of controllers, can perform a series of instructions that result in manipulated data. Processor 1810 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 1810 may be connected to other system elements, including a memory 1812, by bus 1814.

The illustrative computerized device 1800 may also include a network communication device 1820. The network communication device 1820 may receive data from other components of the computerized device to be communicated with servers 1832, databases 1834, smart phones 1836, and/or other computerized devices 1838 via a network 1808. The communication of data may optionally be performed wirelessly. More specifically, without limitation, the network communication device 1820 may communicate and relay information from one or more components of the illustrative computerized device 1800, or other devices and/or components connected to the computerized device 1800, to additional connected devices 1832, 1834, 1836, and/or 1838. Connected devices are intended to include, without limitation, data servers, additional computerized devices, mobile computing devices, smart phones, tablet computers, and other electronic devices that may communicate digitally with another device. In one embodiment, the illustrative computerized device 1800 may be used as a server to analyze and communicate data between connected devices.

The illustrative computerized device 1800 may communicate with one or more connected devices via a communications network 1808. The computerized device 1800 may communicate over the network 1808 by using its network communication device 1820. More specifically, the network communication device 1820 of the computerized device 1800 may communicate with the network communication devices or network controllers of the connected devices. The network 1808 may be, illustratively, the internet. As another example, the network 1808 may be a WLAN. However, skilled artisans will appreciate additional networks to be included within the scope of this disclosure, such as intranets, local area networks, wide area networks, peer-to-peer networks, and various other network formats. Additionally, the illustrative computerized device 1800 and/or connected devices 1832, 1834, 1836, and/or 1838 may communicate over the network 1808 via a wired, wireless, or other connection, without limitation.

Memory 1812 may be used for storing programs and/or data during operation of the illustrative computerized device 1800. Thus, memory 1812 may be a relatively high performance, volatile, random access memory such as a dynamic random-access memory (DRAM) or static memory (SRAM). However, memory 1812 may include any device for storing data, such as a disk drive or other non-volatile storage device. Various embodiments in accord with the present disclosure can organize memory 1812 into particularized and, in some cases, unique structures to perform the aspects and functions of this disclosure.

Components of illustrative computerized device 1800 may be coupled by an interconnection element such as bus 1814. Bus 1814 may include one or more physical busses (illustratively, busses between components that are integrated within a same machine), but may include any communication coupling between system elements including specialized or standard computing bus technologies such as USB, Thunderbolt, SATA, FireWire, IDE, SCSI, PCI and InfiniBand. Thus, bus 1814 may enable communications (illustratively, data and instructions) to be exchanged between system components of the illustrative computerized device 1800.

The illustrative computerized device 1800 also may include one or more interface devices 1816 such as input devices, output devices and combination input/output devices. Interface devices 1816 may receive input or provide output. More particularly, output devices may render information for external presentation. Input devices may accept information from external sources. Examples of interface devices include, among others, keyboards, bar code scanners, mouse devices, trackballs, magnetic strip readers, microphones, touch screens, printing devices, display screens, speakers, network interface cards, etc. The interface devices 1816 allow the illustrative computerized device 1800 to exchange information and communicate with external entities, such as users and other systems.

Storage system 1818 may include a computer readable and writeable nonvolatile storage medium in which instructions can be stored that define a program to be executed by the processor. Storage system 1818 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, illustratively, be optical disk, magnetic disk, or flash memory, among others. In operation, processor 1810 or some other controller may cause data to be read from the nonvolatile recording medium into another memory, such as the memory 1812, that allows for faster access to the information by the processor than does the storage medium included in the storage system 1818. The memory may be located in storage system 1818 or in memory 1812. Processor 1810 may manipulate the data within memory 1812, and then copy the data to the medium associated with the storage system 1818 after processing is completed. A variety of components may manage data movement between the medium and integrated circuit memory element and does not limit the disclosure. Further, the disclosure is not limited to a particular memory system or storage system.

Although the above described illustrative computerized device is shown by way of example as one type of illustrative computerized device upon which various aspects and functions in accord with the present disclosure may be practiced, aspects of the disclosure are not limited to being implemented on the illustrative computerized device 1800 as shown in FIG. 18. Various aspects and functions in accord with the present disclosure may be practiced on one or more computers having components other than that shown in FIG. 18. For instance, the illustrative computerized device 1800 may include specially programmed, special-purpose hardware, such as illustratively, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 1800 may include an operating system that manages at least a portion of the hardware elements included in illustrative computerized device 1800. A processor or controller, such as processor 1810, may execute an operating system which may be, among others, an operating system, one of the above mentioned operating systems, one of many Linux-based operating system distributions, a UNIX operating system, or another operating system that would be apparent to skilled artisans. Many other operating systems may be used, and embodiments are not limited to any particular operating system.

The processor and operating system may work together to define a computing platform for which application programs in high-level programming languages may be written. These component applications may be executable, intermediate (illustratively, C# or JAVA bytecode) or interpreted code which communicate over a communication network (illustratively, the Internet) using a communication protocol (illustratively, TCP/IP). Similarly, aspects in accord with the present disclosure may be implemented using an object-oriented programming language, such as JAVA, C, C++, C#, Python, PHP, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (illustratively, documents created in HTML5, HTML, XML, CSS, JavaScript, or other format that, when viewed in a window of a browser program, render aspects of a graphical-user interface or perform other functions). Further, various embodiments in accord with the present disclosure may be implemented as programmed or non-programmed elements, or any combination thereof. Illustratively, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, illustratively, Database Management Systems such as a SQL Server available from Microsoft of Redmond, Wash., Oracle Database or MySQL from Oracle of Redwood City, Calif., or integration software such as WebSphere middleware from IBM of Armonk, N.Y.

In operation, a method may be provided for analyzing machine learning approaches using a stochastic process and/or other processes and providing a visual representation of same. The stochastic process, the visualization and related components, and/or other processes may be stored in memory. In one embodiment, the stochastic process, analysis of the machine learning output both visual and computational, are stored in memory or stored in a database as part of the method, without limitation.

Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the illustrative operations below after having the benefit of this disclosure. Such additional methods are intended to be included by this disclosure.

In at least one embodiment, a method enabled by this disclosure provides a non-parametric counting process to define the cumulative probability of a responder record occurring by a score segment. A Markov process state space model can be applied to evaluate a stochastic process of observations over the time series classification model score. A new definition for the recall curve may be formulated as the cumulative probability of a responder being classified as a responder, a true positive. The likelihood of response may be attributed to feature inputs used in the black box model, even when the features are time series and in order dependent models such as uninterpretable machine learning classification models, for example, recurrent neural networks. Therefore, a novel method to use information from the time dependence of the features in the explanation and derive local score dependent explanations is provided by this disclosure.

An illustrative method for an operation of a machine learning system enabled by this disclosure will be described, including defining a dataset, without limitation. The operation may begin by sorting the scored dataset by descending score. The operation may then divide the dataset into segments, which can, be without limiting as the only way to segment, one observation or segments with equal number of observations, without limitation. Those having skill in the art will appreciate additional ways to segment the dataset after having the benefit of this disclosure, which are intended to be included within the scope of this disclosure, without limitation. The operation may then calculate summary statistics at each segment. For each segment, the operation may include finding the cutoff score for observations, identifying an interval (sⱼ₋₁, sⱼ) which form the bounds for an observation falling within that segment, as the index set. Nonresponders may be truncated, including removal of observations that are nonresponders. Unlabeled observations may then be censored.

An additional illustrative method for an operation of a machine learning system enabled by this disclosure will be described, namely determining intervals, without limitation. The operation may begin by determining an explanation. Illustratively, the operation may decide whether all intervals are determined. If it is decided that not all intervals are determined, the operation may include determining the intervals. Illustratively, for each interval in (uⱼ₋₁, uⱼ), a product limit estimate or probability of inclusion P(Inclusion) may be calculated for all segments prior to score sᵢ. The probability P(Exclusion) may be calculated, which may be 1−P(Inclusion). It may then be again decided if all intervals are determined. If the decision is that not all intervals are determined, the operation above may be repeated. If it is decided initially or subsequently that all intervals are determined, the operation may continue.

Another illustrative method for an operation of a machine learning system enabled by this disclosure will be described, without limitation. The operation may begin by fitting the proportional hazard regression model and/or the cox proportional hazard model to the product limit estimator to determine a global explanation of which features are important to the model score. Backward and forward feature selection may then be used to identify the significant features. The operation may then fit a generalized additive model to get a local explanation, such as an explanation by segment, of the feature impact to the model. A cutoff point of the model may then be found by showing where the significant variables are no longer significant, as shown on the plot of the coefficients.

An illustrative approach to applying the system and method described throughout this disclosure, such as those enabled by the examples provided throughout, will now be discussed without limitation. An approach inspired by survival analysis may be used for applying a statistical field for measuring time to event data. The foundation of this survival analysis approach may use a counting process derived from Markov processes, which generally defines a random process with independent increments. The Markov process is the model score to observational response in classification models.

An approach using the product limit estimator component may give a score output to each responder and non-responder in the scored dataset from the machine learning model. Scores from the classifier may offer a ranking for which an observation i is likely to be included as a response for category k. The score S may be an output from a machine learning model and can be interpreted as a probability and/or a utility for assigning an observation i to category k. Each observation may be a responder or non-responder. The score given to the observation may be a random variable.

The counting process may use order statistics from a score output file, a confusion matrix may summarize the output of the model at each interval. The interval size may vary to be of equal length or calculated with each additional observation. A cumulative gains table may measure performance of the model for different score cutoffs. Score cutoffs may be defined by an operator and/or determined by a system enabled by this disclosure. In one embodiment, only responders or censored observations are considered in the analysis, while the nonresponders are truncated. The product limit estimator may incorporate the responders and censored observations to create a cumulative distribution function (CDF) of the probability inclusion. The probability of inclusion is the conditional probability of being in-class at a score segment j given the in-class observation had a score greater than s, the score at segment j.

Next, explanations of the black box classification model can be found using input variables as covariates in a proportional hazard regression model, such as provided in the illustrative operation described above, to explain the scores of the responder observations. A multiplicative hazards model may be used to quantify a relationship between the black box model score to responder and a set of explanatory variables. For the purpose of this disclosure, the potential explanatory variables are the input variables used to train the classification model. The explanatory model can be used to find the baseline hazard rate, illustratively, the hazard rate of an observation when all covariates are equal to zero. The effect of the covariates may act multiplicatively on the baseline hazard and may be assumed to be constant across all model scores.

Advantageously, a system and method enabled by this disclosure may further explain the black box classification model by using time dependent covariates in the proportional hazard regression model. Covariates can be time dependent, illustratively recurrent neural networks and time series data. In this model, the baseline hazard rate and/or coefficients in the generalized additive model are dependent on the score given across observations observed over time. The coefficient may be represented by an excess risk at score j for the corresponding covariate. The effects of the covariates may change over score may be arbitrary regression functions.

In another illustrative method, the operation may be performed using the assumption of an underlying Markov process and methods developed in the field of survival analysis or reliability theory. The field models time to event data, such as time to death or time to failure of a component. The field of survival analysis or reliability theory measures statistics such as the proportion of a population that will survive after a point in time through a stochastic counting process. The stochastic counting process may use time as an index to order event data. The novel approach provided by this disclosure advantageously uses the machine learning model score as the index to model the classification event. The product limit estimator may be used to derive a nonparametric statistic, which may estimate a cumulative probability of an observation being a true in-class observation over the black box model score—the probability of inclusion. The probability of inclusion curve is the recall curve in machine learning statistics. By performing the operations enabled by this disclosure, the probability definition of recall can be found using this method.

Observations can also be censored with in-class and out-of-class observations. Censoring may be used when data is missing around the score to the occurrence of an in-class observation process. In one embodiment, a state space of an observation in a binary classification model may use a cardinality of three and may be classified as an in-class observation, an out-of-class observation, or unknown class.

An observation with an unknown class label may be censored where the value of the observation is partially known, such as where the machine learning model score of the observation is known, but the true class of the observation is unknown. An observation may be viewed moving from the out-of-class observation state to an in-class observation state as a stochastic process. An individual observation may move from one state to another due to observation factors which are used as inputs to the black box classification model. The out-of-class observations may be truncated from the analysis, as it may be assumed there is no probability to go from an out-of-class observation to an in-class observation given any feature set for those observations and it can be considered not part of a stochastic process.

Unlabeled observations provide some information with the model score output, which may be incorporated as censored data. Censored observations may be both left and right censored, where it may not be able to observe the class label for the observation with a score less than or greater than the actual score from the model. Censoring is advantageously uninformative because censorship is independent of the black box model score process. Therefore, censorship does not introduce bias if used in finding the product limit estimator. In a system and method enabled by this disclosure, point censoring may be performed such that the score to event data is missing yet there is continuous monitoring of model score over the entire score set.

An illustrative operation may formulate an adaptation of the Markov model as a convenient and intuitive tool for constructing hazard models for an in-class observation to occur at score intervals. The Markov process may be applied in a novel step to simplify the dependence structure of the model score to event stochastic process. The stochastic process event is an observation changing from an out-of-class observation to an in-class observation over the indexed value of the model score. The index set used to index the random variable in this adaptation is the score output from the classification model rather than using time in survival analysis or traditional Markov processes as the index set. Model score is an ordered sequence and is analogous to time. Concepts of a past and a future can be defined in terms of lower or higher score.

This disclosure advantageously provides a novel technique for giving a theoretical definition of the product limit estimator, the logrank hypothesis test, the proportional hazards model, and the generalized additive model to the output of a classification model to explain the black box decision. The empirical calculation for the product limit estimator and the algorithm to explain the black box model is given using feature factors from the proportional hazards model and generalized additive models. Black box model scores may be simulated and an improvement to significance tests may be performed to increase in power using the logrank test from the Student's T-test and Wilcoxon signed-rank test when comparing the performance of black box models.

Illustrative example calculations that may be used to derive an explanation will now be discussed, without limitation. Calculations will be discussed for the probability of inclusion, hypothesis tests for the probability of inclusion, proportional hazards regression explanation, and the score dependent additive regression explanation. A generic algorithm will also be described that may be used to arrive at model comparisons and model explanations. Illustratively, a researcher would create a black box machine learning classification model or a series of models and would have the need to evaluate and explain the models. The researcher would derive the probability of inclusion, also known as the recall curve. She would perform hypothesis tests to determine if performances are statistically significantly different. Then, she would explain the model using multiplicative hazards model, such as a proportional hazards regression model, along with a score dependent additive regression if the effect of the features on the baseline hazard rate is score dependent.

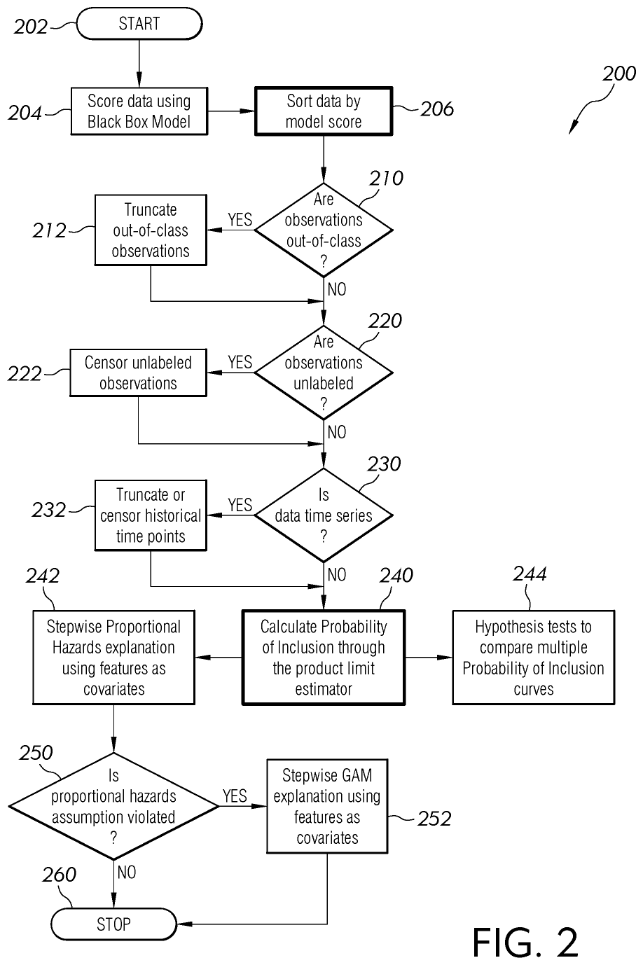

Referring now to flowchart 200 of FIG. 2, an illustrative method for an operation performable by a system enabled by this disclosure will be described, without limitation. Starting with Block 202, the operation may begin by scoring data using a black box model (Block 204). The operation may then sort data by model score (Block 206). It may then be determined whether observations are out-of-class (Block 210).

If it is determined at Block 210 that observations are out-of-class, the operation may truncate out-of-class observations (Block 212). If it is determined at Block 210 that the observations are out-of-class, or after the operation of Block 212, it may then be determined whether observations are unlabeled (Block 220).

If it is determined at Block 220 that observations are unlabeled, the operation may censor unlabeled observations (Block 222). If it is determined at Block 220 that the observations are unlabeled, or after the operation of Block 222, it may then be determined whether the data is time series (Block 230).

If it is determined at Block 230 that data is time series, the operation may truncate and/or censor historical time points (Block 232). If it is determined at Block 230 that the data is not time series, or after the step of Block 232, the operation may calculate a probably of inclusion through the product limit estimator (Block 240). The operation may then progress to apply a stepwise proportional hazards explanation using features as covariates (Block 242). From the step of Block 240, the operation may additionally apply hypothesis tests to compare multiple probability of inclusion curves (Block 244).

After the step of Block 242, it may be determined whether a proportional hazards assumption is violated (Block 250). If it is determined at Block 250 that a proportional hazards assumption is violated, the operation may apply a stepwise generalized additive model explanation using features as covariates (Block 252). If it is determined at Block 250 that the proportional hazards model is not violated, or after the step of Block 252, the operation may then stop at Block 260.

Calculations and Theory

Illustrative data transformation, including example calculations and theory, will now be discussed, without limitation. A system and method, such as ones described by this disclosure, may derive score dependent explanations for classification models and produce a global explanation for the feature influence and a local explanation for the feature influence by model score neighborhood. Such a system and method may also identify hypothesis tests that can advantageously be performed on the probability of inclusion curves between more than one model.

The input to the model explanation may be the independent variables (such as feature data used to train the black box model) and at least one dependent variable (such as a black box model score derived from the black box model). Observations may be ordered by score. The explanation may begin by truncating the out-of-class observations. In-class observations and/or observations with an unknown label may remain after truncation.

Next, estimations of a probability of inclusion of the observations over the black box model score may be calculated with the in-class observations as an event and the unlabeled observations as censored at the score index. With two or more black box model results, the probability of inclusion can be used to calculate nonparametric hypothesis test statistics, such as the logrank or Wilcoxon hypothesis test statistics. Hazard may be derived over the model score from the probability of inclusion. Coefficients may be determined by applying a multiplicative hazards model, such as a proportional hazards regression model, without limitation. Score dependent coefficients in the generalized additive model may then be determined. It should be noted a time dependent structure of the feature data may be included by treating the historical observations as if their label is unknown. Historical observations may be censored because it may not have been known whether the observation would be in-class or out-of-class at the time the data was collected.

An illustrative operation, including an illustrative computational theory, will now be discussed, without limitation. This illustrative operation may be read along with Exhibit 1, provided below:

Exhibit 1
Exhibit I: Score Dependent Model Explanation for Time Dependent Data

```
1. Input: score pouts s, s₁, . . . , sₖ such that s₁ < . . . < sₖ₋₁ < sk and
    integers x, x₁, . . . , xₖ
2 Output: max L₍β)
    1: if x = 1 or x ∈ (0, 1) then
    2: I(s) = P( S > s)
    3:  $α ( s ) = \frac{- {I}^{′} ( s )}{I ( s )}$
    4: solve α(s|X) =α₀(s)exp(Σ_{k = 1}^{p}βₖXₖ)
    5: if \hat{β}ᵢₛ ≠ \hat{B} ᵢ₀∀s then
    6: α(s|xᵢ) = β₀(s)+β₁(s)xᵢ₁(t) + . . . +βₚ(s)xᵢₚ(t))
    7: end if
    8: return B
    9: end if
```

In the illustrative operation, the stochastic process may be derived over the model score. The Markov model may describe the risk process of in-class observations over the black box classification model score. Referencing Equation 3, X(s) is Markov if:

P(X(s)=x|X(sₖ)=xₖ,X(sₖ−1)=xₖ−1, . . . ,X(s₁)=x₁)=P(X(s)=x|X(sₖ)=xₖ) Equation 3

for any selection of score points s, s₁, . . . , sₖ such that s₁< . . . <sₖ and integers x, x₁, . . . , xₖ. The assumption holds as long as the value of X at lower scores is uninformative when predicting outcomes of X at higher scores, or lower scores and higher scores are independent given the score s. The Markov property is score-homogenous when the transition probabilities only depend on the score s and not on the starting score. A black box model score is the output given the current set of feature inputs and is independent of other instances for both their feature inputs and model score outputs. The following are derived from parallel survival analysis equations, as will be appreciated by those of skill in the art.

Illustrative calculations relating to hazard will now be discussed, without limitation. Let the model score S be a random variable with the inclusion function I(s)=P(S>s). It can be assumed that the inclusion function I(s) is absolutely continuous. Let f(s) be the density of S. The standard definition of the hazard rate (s) of S is the following with ds being infinitesimally small, as seen in Equation 4.

$$I ( s ) = P ( S > s ) = 1 - F ( s ) = {\int }_{s}^{∞} f ( s ) ds \\ α ( s ) = {lim}_{Δ s -> 0} \frac{1}{Δ s} P ( s \leq S \leq s + Δ s \vert S \geq s ) = \frac{f ( s )}{I ( s )} \qquad Equation 4$$

The probability of being in-class occurs in the immediate next score output. This way, alpha is obtainable from S, as seen in Equation 5.

$$α ( s ) = \frac{- {I}^{′} ( s )}{I ( s )} \qquad Equation 5$$

Because −f(s) is the derivative of I(s) the expression can be rewritten as seen in Equation 6.

$$α ( s ) = \frac{- d}{ds} log ( I ( s ) ) \\ I ( s ) = {exp}^{- {\int }_{0}^{s} α ( s ) ds} \qquad Equation 6$$

Illustrative calculations regarding application of a Markov process will now be discussed, without limitation. The classification model output relates to a Markov process where the transition properties are score dependent. Let X(s) be defined by the state space 0; 1 and by the transition intensity matrix of Equation 7.

$$α ( s ) = [ \begin{matrix}- α ( s ) & α ( s ) \\ 0 & 0\end{matrix} ] \qquad Equation 7$$

State 1 is thus absorbing, and the intensity of leaving state 0 and entering state 1 is α(s) at score s. See Equation 8.

$$\begin{matrix}P ( s ) = [ \begin{matrix}I ( s ) & 1 - I ( s ) \\ 0 & 1\end{matrix} ] \\ = [ \begin{matrix}{exp}^{( - {\int }_{0}^{s} α ( s ) ds )} & 1 - {exp}^{( - {\int }_{0}^{s} α ( s ) ds )} \\ 0 & 1\end{matrix} ]\end{matrix} \qquad Equation 8$$

The Chapman-Kolmogorov equations for the forward equation is the following when the transition probabilities are absolutely continuous, as shown in Equation 9.

$$\frac{\partial }{\partial s} P ( t , s ) = P ( t , s ) α ( s ) \\ α ( s ) = {lim}_{Δ s -> 0} \frac{1}{Δ s} ( P ( s , s + Δ s ) - I ) \qquad Equation 9$$

To find the solution for the general case we apply the Chapman-Kolmogorov equations (Equation 10) where s=s₀<s₁<s₂< . . . <sₖ=s.

P(t,s)=P(s₀,s₁)P(s₁,s₂) . . . P(s_{K-1},s_{K}) Equation 10

When the lengths of the subintervals u∈(t; s] go to zero, we arrive at the solution as a matrix product-integral shown in Equation 11.

$$P ( t , s ) = {\prod }_{u ∈ ( t , s ]} \{ I + α ( u ) du \} \\ I ( s ) = {\prod }_{u \leq s} ( 1 - dA ( u ) ) \qquad Equation 11$$

When A is absolutely continuous, we write dA(u)=a(u)du. See Equation 12.

$$\begin{matrix}I ( s ) = {\prod }_{u \leq s} ( 1 - dA ( u ) ) = {\prod }_{u \leq s} ( 1 - α ( u ) du ) \\ = exp \{ - {\int }_{u \leq s} α ( u ) du \} \\ = {exp}^{- A ( s )}\end{matrix} \\ A ( s ) = - {\int }_{0}^{s} \frac{dI ( u )}{I ( {u}^{-} )} \qquad Equation 12$$

We simplify the version of 1(s) where we consider the conditional inclusion function shown by Equation 13.

$$I ( v \vert u ) = P ( S > v \vert S > u ) = \frac{I ( e )}{I ( u )} \qquad Equation 13$$

This is the probability of the in-class observation having a score v given that it has not occurred at score u, where v>u.

Illustrative calculations relating to the product limit estimator will now be discussed, without limitation. To find the product limit estimator curve, the ordered score data may be partitioned into intervals and use the multiplication rule for conditional probabilities to find the probability of inclusion. In this illustrative calculation, the probability of inclusion is the conditional probability that the in-class observation will occur with at least the score s given that the observation has not received a lower score. We define D(s) as the count of the number of in-class observations up until score s and d(s) as the number of in-class observations at score s not including the censored observations at s. Y(s) is the count of records at risk “just before” score s, the number of records at risk are the number of in-class or censored observations remaining with a score equal to or greater than s. The standard estimator for the inclusion function is defined for this illustrative calculation in Equation 14 for all values of sin the range where there is data.

$$I ( s ) = {\prod }_{k = 1}^{K} I ( {s}_{k} \vert {s}_{k - 1} ) \qquad Equation 14$$

The product limit estimator, evaluated at a given score s, is approximately normally distributed in large samples. A standard 100 (1−α)% confidence interval for I(s) takes the form shown in Equation 15.

$$\hat{I} ( s ) = \pm {z}_{1 - \frac{α}{2}} \hat{τ} ( s ) \\ {\hat{τ}}^{2} ( s ) = {\hat{I} ( s )}^{2} {\sum }_{{I}_{j} < s} \frac{1}{{Y ( {S}_{j} )}^{2}} \qquad Equation 15$$

To derive the asymptotic distribution of the product limit estimator we establish the right-hand side as a stochastic integral, therefore it is a mean zero martingale. See Equation 16.

$$\frac{\hat{I} ( s )}{{I}^{*} ( s )} - 1 = - {\int }_{0}^{s} \frac{\hat{I} ( {u}^{-} )}{{I}^{*} ( u )} d ( \hat{A} - {A}^{*} ( u ) ) \\ {I}^{*} ( s ) = {\prod }_{u \leq s} \{ 1 - {dA}^{*} ( u ) \} \qquad Equation 16$$

For all values of s beyond the largest observation score or before the smallest observation score the estimator is not well defined. The product limit estimator is a step function with jumps at the in-class observation scores. The in-class observations at score s and the censored observations just prior to score s determine the size of the jumps in the step function, as applied in Equation 17.

$$\hat{I} ( s ) = \{ \begin{matrix}1 , & if s < {s}_{1} \\ {\prod }_{{s}_{i} \leq s} [ 1 - \frac{{d}_{i}}{{Y}_{i}} ] , & if {s}_{i} \leq s\end{matrix} \qquad Equation 17$$

The variance of the product limit estimator is estimated by the following Equation 18.

$$\hat{V} [ \hat{I} ( s ) ] = {\hat{I} ( s )}^{2} {\sum }_{{s}_{i} \leq s} \frac{{d}_{i}}{{Y}_{i} ( {Y}_{i} - {d}_{i} )} \qquad Equation 18$$

The cumulative hazard has a unique relationship with the product limit estimator and is defined as shown in Equation 19.

$$\hat{A} ( s ) = \{ \begin{matrix}0 , & if s \leq {s}_{1} \\ {\sum }_{{s}_{i} \leq s} \frac{{d}_{i}}{{Y}_{i}} , & if {s}_{i} \leq s\end{matrix} \\ {σ}_{A}^{2} ( s ) = {\sum }_{{s}_{i} \leq s} \frac{{d}_{i}}{{Y}_{i}^{2}} \qquad Equation 19$$

Illustrative calculations relating to the hypothesis test will now be discussed, without limitation. Nonparametric hypothesis tests may compare the distribution of two probability of inclusion curves. Under the null hypothesis the two models have the same hazard functions for in-class observations and, under the alternative, at least one score Iᵢ(s) is different for some sᵢ, as seen in Equation 20.

H₀:I₁(s)=I₂(s)= . . . =Iₕ(S) for all s

H₁: at least one Iᵢ(s) is different for some s Equation 20

A vector v may be computed whose components are given by the following definitions where s₁<s₂< . . . <sₖ and let W(s₁) be a positive weight function, nᵢⱼ be the size of the risk and dᵢⱼ the number of in-class observations for the i-th score (Equation 21).

$$\begin{matrix}{n}_{i} = {\sum }_{j} {n}_{ij} & Equation 21 \\ {d}_{i} = {\sum }_{j} {d}_{ij} \\ {v}_{i} = {\sum }_{i = 1}^{D} W ( {t}_{i} ) ( {d}_{ij} - \frac{{n}_{ij} {d}_{i}}{{n}_{i}} ) & \end{matrix}$$

The term vᵢ is a interpreted as a weighted sum of observed, minus the expected number of failures under the null hypothesis of identical probability of inclusion curves. The calculation may define \hat{V} as the covariance matrix of v and X² as the test statistic. See Equation 22.

$$diagonal {\hat{V}}_{i} = \frac{{n}_{ij} ( {n}_{i} - {n}_{ij} ) {d}_{i} ( {n}_{i} - {d}_{i} )}{{n}_{i}^{2} ( {n}_{i} - 1 )} \\ off diagonal {\hat{V}}_{i} = \frac{{n}_{ij} {n}_{ij} {d}_{i} ( {n}_{i} - {d}_{i} )}{{n}_{i}^{2} ( {n}_{i} - 1 )} \\ {X}^{2} = {v}^{T} {\hat{V}}^{- 1} v \qquad Equation 22$$

The test statistic X² follows a chi-squared distribution with h degrees of freedom, where h is the number of groups. The weight function W(s₁) determines the type of test. The logrank test corresponds to W(s)=1 for all s. The Wilcoxon test sets W(sⱼ)=nⱼ.

It can be appropriate to use these hypothesis tests with censored unlabeled observations. The hypothesis test statistics compare estimates of the hazard functions of groups of machine learning models at each observed model score.

Illustrative calculations relating to the proportional hazards regression model, an example of a multiplicative hazards model, will now be discussed without limitation. The proportional hazards regression model approximates the effects of the model covariates. In this illustrative calculation, the proportional hazards regression is a multiple linear regression of the logarithm of the hazard on the set of covariates, with the baseline hazard being an intercept term that varies with score. Covariates can be categorical or continuous and can also be time dependent. Time dependent features may be incorporated as additional observations in the data with a censored class. The theoretical derivation remains the same, as seen in Equation 23.

$$α ( s \vert Z ) = {α}_{0} ( s ) c ( {β}^{*} Z ) \\ α ( s \vert Z ) = {α}_{0} ( s ) exp ( {β}^{s} Z ) = {α}_{0} ( s ) exp ( {\sum }_{k = 1}^{p} {β}_{k} {Z}_{k} ) \qquad Equation 23$$

where α₀(s) is an arbitrary baseline hazard rate. The parametric form is only assumed for the covariate effect. The baseline hazard rate is nonparametric. α(s/Z) must be positive. The model is called proportional hazards model because two observations with covariate values Z and Z* have a ratio of hazard rates as seen in Equation 24.

$$\frac{α ( s \vert Z )}{α ( s \vert {Z}^{*} )} = \frac{{α}_{0} ( s ) exp ( {\sum }_{k = 1}^{p} {β}_{k} {Z}_{k} )}{{α}_{0} ( s ) exp ( {\sum }_{k = 1}^{p} {β}_{k} {Z}_{k}^{*} )} = exp ( {\sum }_{k = 1}^{p} {β}_{k} ( {Z}_{k} - {Z}_{k}^{*} ) ) \qquad Equation 24$$

The hazard rates are proportional. If only one covariate, Z₁, differs and is categorical while all other covariates remain the same between Z and Z*, the proportional hazards become as shown in Equation 25.

$$\frac{α ( s \vert Z )}{α ( s \vert {Z}^{*} )} = exp ( {β}_{1} ) \qquad Equation 25$$

The likelihood of the Beta vector is as seen in Equation 26.

$${L}_{1} ( β ) = {\prod }_{i = 1}^{D} \frac{exp ( {β}_{s} {s}_{i} )}{{\sum }_{j ∈ {R}_{i}} {exp ( {β}_{s} {Z}_{j} )}^{{d}_{i}}} \qquad Equation 26$$

Illustrative calculations relating to the general additive model will now be discussed, without limitation. In this illustrative calculation, a local explanation is introduced for a score neighborhood. The proportional hazards model incorporates time dependent features where the hazard rate is constant across all the model scores, however score dependent covariates may be used through an additional modeling step to fit score dependent coefficients using a GAM when the proportional hazards assumption is violated. Estimation of the additive nonparametric model focuses on the cumulative regression functions of Equation 27.

B_{q}(s)∫₀^{s}β_{q}(u)du Equation 27

Where the estimation is performed at each score by regressing for the observations at risk on their covariates, Equation 28 applies.

$$α ( s \vert {x}_{i} ) = {β}_{0} ( s ) + {β}_{1} ( s ) {x}_{i 1} ( s ) + … + {β}_{p} ( s ) {x}_{ip} ( s ) \\ {λ}_{i} ( s ) = {Y}_{i} ( s ) \{ {β}_{0} ( s ) + {β}_{1} ( s ) {x}_{i 1} ( s ) + … + {β}_{p} ( s ) {x}_{ip} ( s ) \} \\ {dD}_{i} ( s ) = {λ}_{i} ( s ) ds + {dM}_{i} ( s ) \\ {dD}_{i} ( s ) = {Y}_{i} ( s ) d {B}_{0} ( s ) + {\sum }_{j = 1}^{p} {Y}_{i} ( s ) {x}_{ij} ( s ) d {B}_{j} ( s ) + {dM}_{i} ( s ) \\ for i = 1 , 2 , … , n \qquad Equation 28$$

This relation has the form of an ordinary linear regression model where the dDᵢ(s) are the observations, the Yᵢ(s)xᵢⱼ(s) are the covariates, the λᵢ(s) are the intensity processes, the αᵢ(s) are the score dependent hazard rates, the dBⱼ(s) are the parameters to be estimated, and the dMᵢ(s) are the random errors. Observation i is a member of the risk set at score s. Estimation is defined over the score interval where Y(s) has full rank, meaning the covariates used for the explanation are linearly independent.

Experimentation—Time to Failure Analysis

An illustrative example is now provided below to demonstrate an application of the above disclosure. First, the data used will be discussed, without limitation. In this example, data was chosen as time to failure data of Blackblaze hard drives (HDDs), which has published time series hard drive reliability statistics and insights based on hard drives in their data center. The data published are SMART (Self-Monitoring, Analysis and Reporting Technology) statistics used by hard disk drive manufacturers to determine when disk failure is likely to happen.

The goal of this experimentation was to explain predictions in hard drive failure using reliability statistics. The experimentation also was focused to show improvement to existing methods for comparing machine learning model performance by simulating model score output and showing that the logrank hypothesis test improves the Wilcoxon and Student's T hypothesis tests.

Training

The experiment was performed on open data to show the value of the explanation method. The data chosen was time to failure data of Blackblaze hard drives, which has published time series hard drive reliability statistics and insights based on hard drives in their data center. The data published are SMART (Self-Monitoring, Analysis and Reporting Technology) statistics used by hard disk drive manufacturers to determine when disk failure is likely to happen. The hard drives self-report the statistics and they are collected daily. Manufacturers and models do not have a standard form of collecting data, so a year of data for one model was used for this experimentation—the Seagate Model ST4000DM000 hard drive.

The Raw SMART 9 statistic is the count of hours the device has been powered on, which is used as the time variable in the data and normalize to years. All other SMART statistics are normalized to be between 0 and 1 from the raw data collected. Data was collected at a daily rate and a failure is recorded the day before the device fails or the last working day of the device ensuring the model is causal.

A deep LSTM network was structured to learn when a hard drive will fail. The LSTM network was structured to have three LSTM layers with 128 artificial neurons followed by two fully connected layers with 128 artificial neurons and 1 fully connected layer with 1 artificial neuron, as will be appreciated by those of skill in the art. The network used a lookback window of 5 days of SMART statistics. There are 24 normalized SMART statistics and 21 raw SMART statistics used as covariates, which are again normalized to be between 0 and 1. The model used relu activation functions and a drop out level of 0.2 for the LSTM layers. The model also used a sigmoid activation function and 12 regularization of 0.002 for the fully connected layers. Adam optimizer is used with learning rate of 0.001.

The model was trained in three hundred epochs with a batch size of 30 observations. The training classes fed into the RNN were balanced classes. The neural network saw the last five days of SMART statistics during training. The precision for the test data is 0.9469 and recall is 0.6564, the highest achieved with all available knowledge.

Explanation

The probability of inclusion, or the product limit estimator, shown in FIG. 3 is calculated by looking at all data from failed devices and their scores. Using time dependent data allows consideration of the data in the look back window as censored observations because it is unknown whether the device at these statistics would fail at the time the data was collected. Covariates which are collinear were removed from the proportional hazards analysis and only one covariate is used in the regression. Forwards and backwards selection were used in the regression to determine the final significant covariates for the global explanation. The final covariates were chosen due to a combination of minimizing the standard error of the proportional hazards regression as well as having significant coefficients.

One thing that should be considered when interpreting the regression coefficients is that the feature selection changes the baseline hazard rate for the observations. This explanation shows the baseline hazard rate for the hard drive is significantly impacted with only three reliability statistics. The results of the time dependent proportional hazards model are in Table 3, provided below in the experimentation section relating to the simulation experiment. The ! column in Table 3 denotes that the feature has been found as a critical feature from other studies.

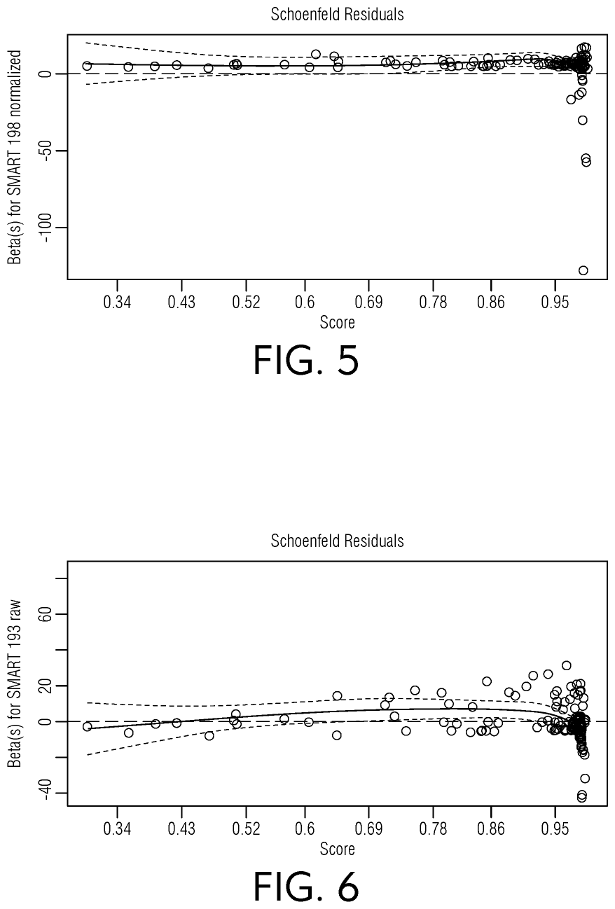

The Schoenfeld residuals were plotted to check the proportional hazards assumption and the plots indicate that the proportional hazards assumption may be violated for the highest score segments as there are numerous residuals which are outliers in one direction. FIG. 4 plots the Schoenfeld Residuals for SMART 187 normalized. FIG. 5 plots the Schoenfeld Residuals for SMART 198 normalized. FIG. 6 plots the Schoenfeld Residuals for SMART 193 raw.

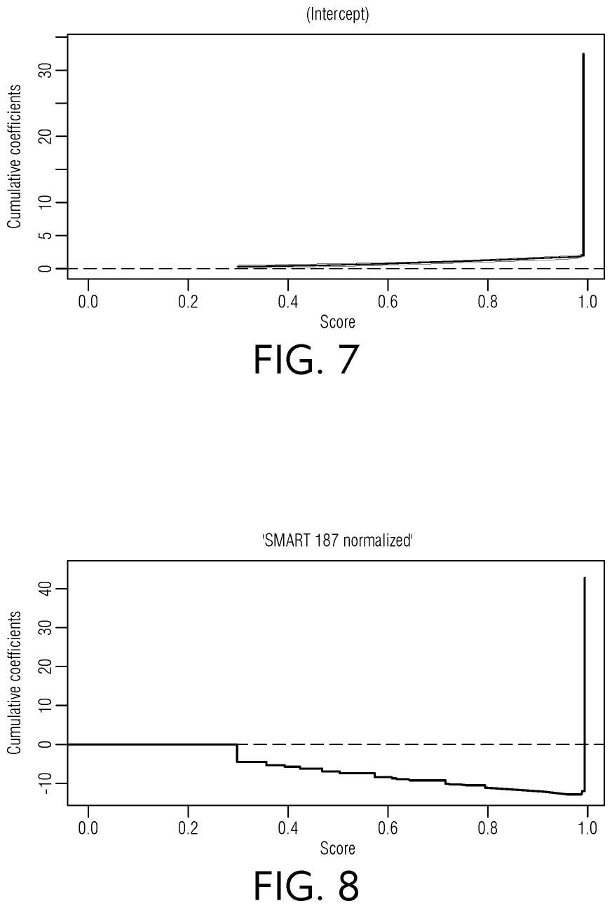

The coefficients were then evaluated using score dependence for the coefficients and time dependence for the features using a generalized additive model and show that the feature coefficients are score dependent. FIG. 7 plots the cumulative baseline hazard. FIG. 8 plots the cumulative coefficient for SMART 187 normalized.

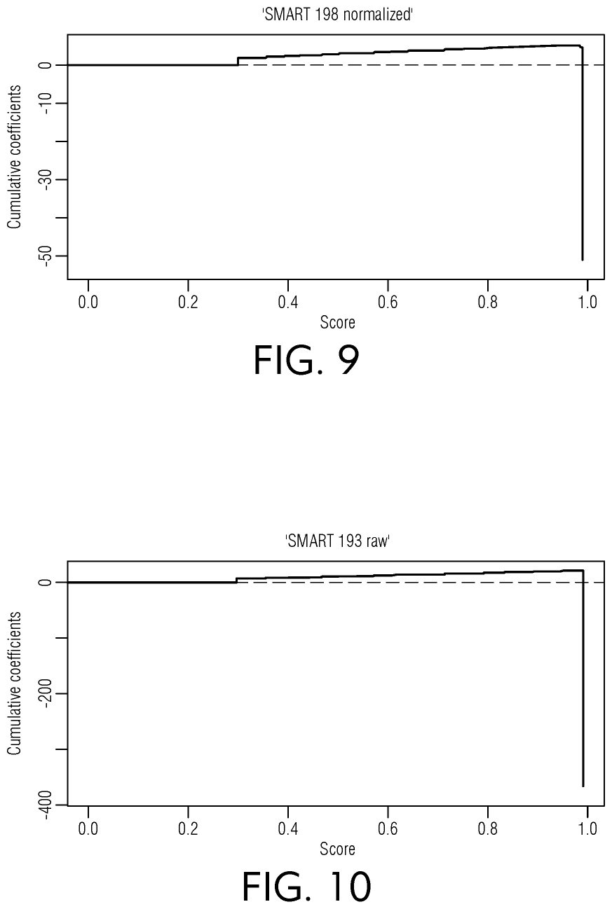

FIG. 9 plots the cumulative coefficient for SMART 198 normalized. FIG. 10 plots the cumulative coefficient for SMART 193 raw. The cumulative coefficient plots should show the coefficients following a linear trend throughout the score in order to fall under the proportional hazards assumptions. The cumulative coefficient plots show a switch in direction of trend, where positive coefficients are negative for the highest scores and negative coefficients are positive for the highest scores. The plots show that SMART 187 normalized has a large positive coefficient for the first score segment, and a negative coefficient for later segments. SMART 198 normalized and SMART 193 raw are coefficients that are positive for the first score segment and negative for the remaining score segments. In each of the cumulative coefficient plots, 0 is not within the confidence intervals but the coefficients change sign. The large positive coefficients indicate the feature has association with increased risk for the observation to experience hard drive failure.

Prominent features may differ between hard drive manufacturers and models. The experimentation identified SMART 187, SMART 198, and SMART 193 statistics as features that have caused the hard drive to fail, while Blackblaze has identified SMART 5, SMART 187, SMART 188, SMART 197, and SMART 198 as metrics indicating impending failure across manufacturers. The experimentation saw that SMART 197 and SMART 198 are completely correlated, so SMART 197 was removed from the analysis to avoid collinearity in the regression.

SMART 187 measures the reported uncorrectable errors, the count of errors that could not be recovered using hardware error-correcting code (ECC) memory. Blackblaze uses this statistic to determine hard drive failure, the drive is replaced when this statistic goes above 0. SMART 197 measures the current pending sector count, or the count of sectors waiting to be remapped because of unrecoverable read errors. It is also a strong indicator for hard drive failure for Blackblaze. SMART 193, the load cycle count, does not have a significant p-value, but the inclusion of this feature minimizes the standard error. Customer and technical support forums confirm that SMART 193 is not an indicator by itself for hard drive failure unless other statistics, such as SMART 197, indicate failures as well.

It can be difficult to benchmark the method of this experimentation because of the limited methods that exist in the current state of the art. The experimentation could not find comparable results or analysis that could explain the classification model. The experimentation benchmarked against the first order Taylor expansion or the MSE Ratio, which quantifies the sensitivity of the feature if the value is set to 0 for all observations. The experimentation found that SMART 1 raw (0.048), SMART 3 normalized (0.031), and SMART 242 raw (0.023) have the largest absolute MSE Ratio of all the features. No other studies found these features to be of great importance when evaluating potential failure of a hard drive. It can be difficult to interpret the MSE ratio of the features because it only shows relative importance without a clear interpretation of the effect the feature had to the model. The experimentation does not recommend this method.

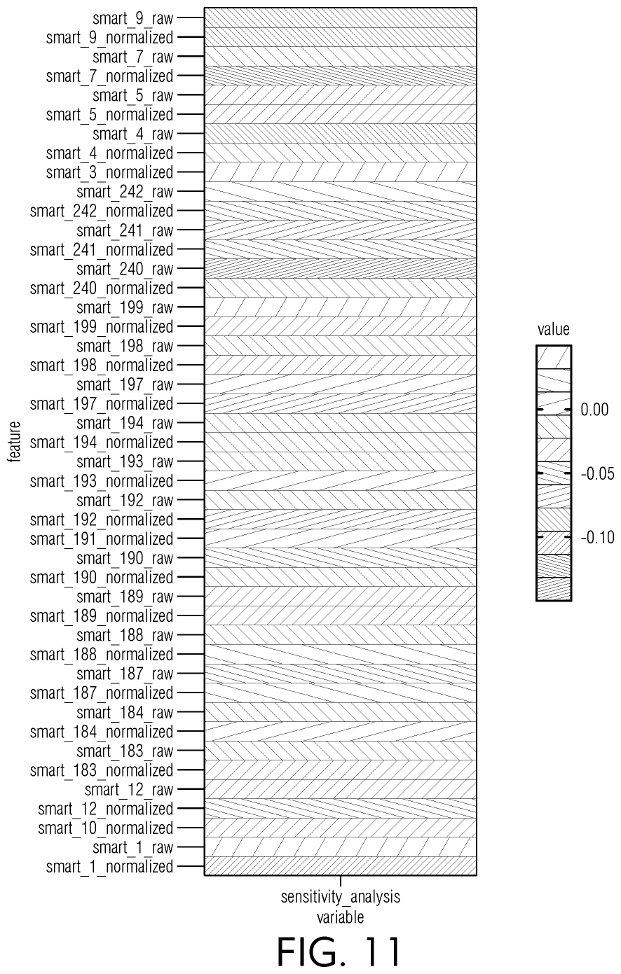

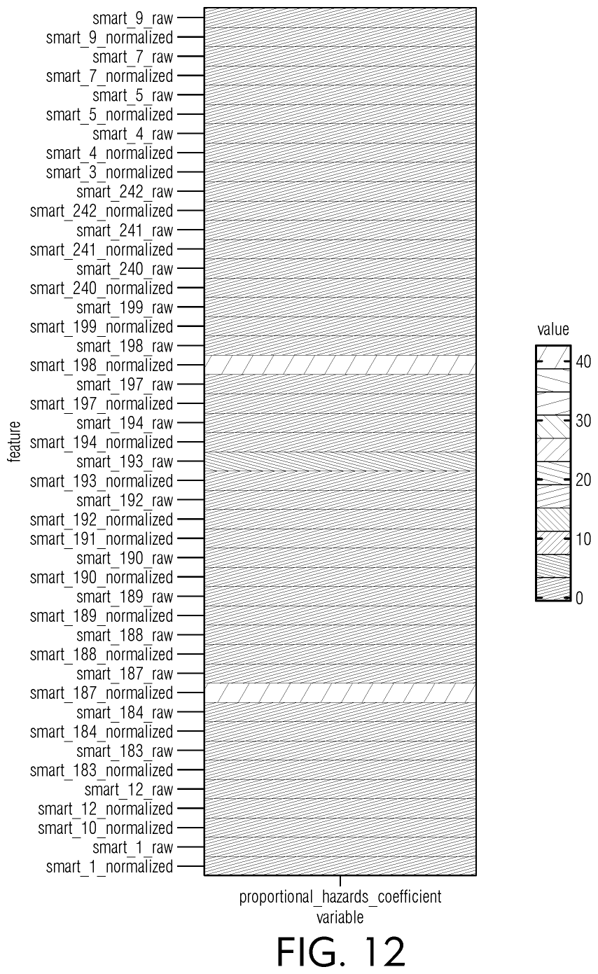

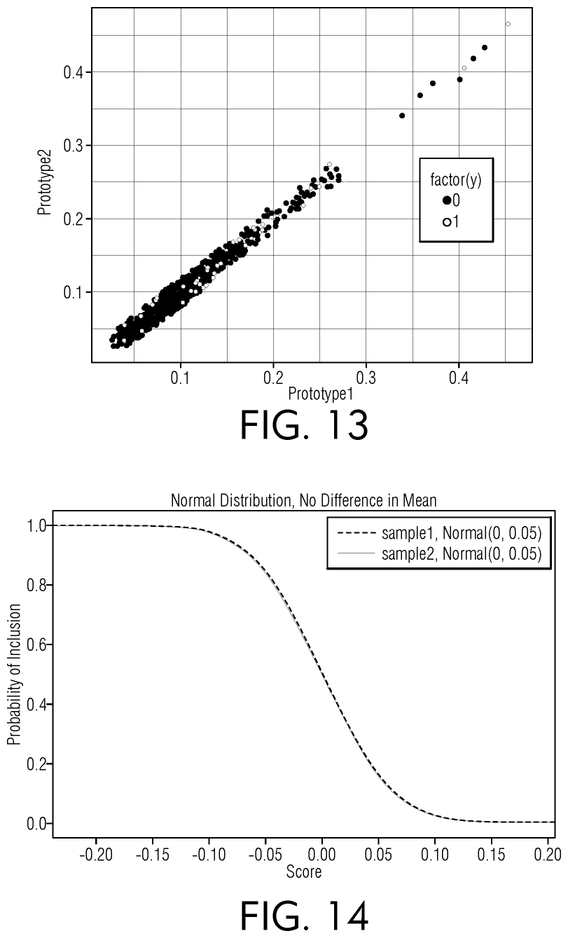

FIG. 11 plots a heatmap of the MSE Ratio, First Order Taylor Expansion salience, where all the features have a small effect on the model score. For comparison, FIG. 12 plots a heatmap of the proportional hazards regression. The experimentation was able to see that select features have a clear effect on the model score in the proportional hazards explanation. A second benchmark is given in the form of a visual representation of prototypes. FIG. 13 plots the learned prototypes for each observation by their classification. The experimentation altered the architecture to use an explainable model which trained prototypes; however, it did not find linearly separable prototypes. Therefor this method did not result in an explanation of the black box model.

### Simulation Experiment

The experimentation shows improvement to available methods to compare machine learning models. The analysis from the experimentation was performed under two assumptions where machine learning black box model scores follow a Normal distribution and the second that the scores follow a Beta distribution. The experimentation compared the Type I error and error of the logrank, Wilcoxon, and T-tests on the probability of inclusion function of the paired samples.

The experimentation simulated 1000 paired samples of in-class model scores using the Normal and Beta distributions with no difference in mean. The experimentation also simulated 1000 paired samples of in-class model scores using the Normal and Beta distributions with 0.2 difference in mean.

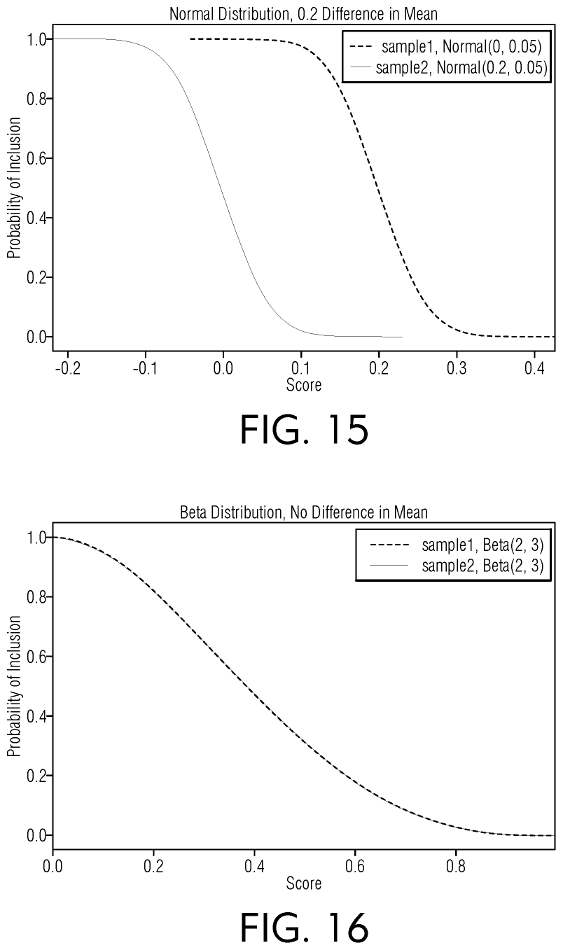

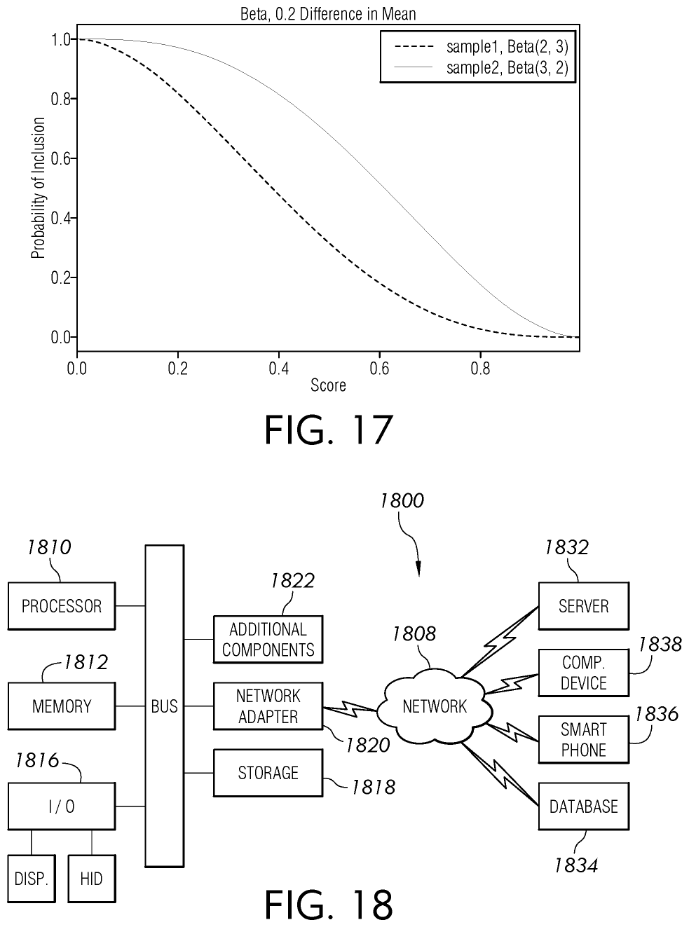

FIG. 14 shows the probability of inclusion curves for a Normal distribution with no difference in the mean. FIG. 15 shows the probability of inclusion curves for a Normal distribution with 0.2 difference in the mean. FIG. 16 shows the probability of inclusion curves with a Beta distribution with no difference in the mean. FIG. 17 shows the probability of inclusion curves with a Beta distribution with 0.2 difference in the mean. The results in Table 1 show an average of the Type I error and the results in Table 2 show the Power of the tests.

TABLE 1
Proportional Hazards Explanation with Time Dependent Data

| Covariate | Coeff | exp(Cooff) | se(Coeff) | Pval | MSE Ratio | I |
|---|---|---|---|---|---|---|
| SMART 187 | 3.79 | 44.03 | 0.83 | 0.00 | 0.016 | Y |
| normalized | | | | | | |
| SMART 198 | 3.59 | 36.30 | 0.93 | 0.0 | −0.010 | Y |
| normalized | | | | | | |
| SMART 193 | 0.27 | 1.3 | 1.00 | 0.79 | −0.011 | N |
| raw | | | | | | |

TABLE 2
Summary for Type I Error, α = 0.05, 1000 Iterations

| | μ | | Logrank | T-Test | Wilcoxon |
|---|---|---|---|---|---|
| Distribution | Delta | N | P-Value | P-Value | P-Value |
| Normal(0, 0.05) | 0.0 | 1000 | 0.4979 | 0.00 | 0.00 |
| Normal(0.2, 0.05) | 0.2 | 1000 | 0.00 | 0.00 | 0.00 |
| Beta(2, 3) | 0.0 | 1000 | 0.503 | 0.00 | 0.00 |
| Beta(3, 2) | 0.2 | 1000 | 0.00 | 0.00 | 0.00 |

TABLE 3
Summary for the Power, α = 0.05, 1000 Iterations

| | μ | | Logrank | T-Test | Wilcoxon |
|---|---|---|---|---|---|
| Distribution | Delta | N | P-Value | P-Value | P-Value |
| Normal(0, 0.05) | 0.0 | 1000 | 0.056 | 1.0 | 1.0 |
| Normal(0.2, 0.05) | 0.2 | 1000 | 1.000 | 1.0 | 1.0 |
| Beta(2, 3) | 0.0 | 1000 | 0.043 | 1.0 | 1.0 |
| Beta(3, 2) | 0.2 | 1000 | 1.0 | 1.0 | 1.0 |

The Type I error results show that the logrank test outperforms the T-test and the Wilcoxon rank sum tests because it does not reject the null hypothesis when the null hypothesis is true. The Power of the test shows that the logrank test has just as much power as the T-Test and Wilcoxon rank sum test when the null hypothesis should be rejected, or when the observations across model score come from different distributions. The experimentation concluded that there is an improvement in available methods to compare the recall curve or the probability of inclusion estimate by using the logrank hypothesis test over the Wilcoxon and Student's T hypothesis tests.

Discussion

The experimentation emphasizes topics around the stochastic process application for transparent explanation of classification models that were considered during the theoretical derivation and experimentation. First, the experimentation performed a hypothesis test to substantiate an assumption of the absorbing in-class state in the Markov model. Secondly, the experimentation acknowledges that there is a change in the base hazard rate for each regression model by using stepwise selection for the explanatory variables at the risk of creating variability in explanations for one black-box model. Thirdly, the experimentation indicates that the applications systems and methods enabled by this disclosure in XAI applications advantageously improve fairness and trust.

Under the Markov model, a counterfactual observation which receives a score less than the actual observation has possible outcomes either to be in-class or out-of-class but a counterfactual observation which receives a score greater than the actual observation is assigned in-class. The experimentation tests the assumption that if an observation has failed at a score output s, then a score output \hat{ }s greater than s would indicate the observation is in-class. The assumption is established by the Markov process where the event only occurs once therefore the failure of a hard drive is an absorbing state over the index set. The experimentation showed that the observations received a significantly greater score when the hard drive failed than in previous time steps. Under the experimentation, reason was found to reject the null hypothesis with an alpha of 0.10 in a one-sided t-test where the null hypothesis is that there is no difference between the mean score s of observations at t and the mean score s of observations at t−n for all n>0 and n<5. The test statistic received through the experimentation was 1.9978.

The experimentation used forwards and backwards selection to find covariates for the explanation. The experimentation showed limitations in selecting the covariates for the proportional hazards regression. This process improves the fit of the regression, but the method may produce variable results. It may be advantageous to use this method in industry because the method excludes features which are collinear and non-statistically significant in the explanation, thus simplifying the explanation. It may be easier to communicate the impact from a smaller set of features than to communicate that the effect is spread over the entire feature set. In the advertising technology industry, applying the systems and methods enabled by this disclosure may be favorable to identify few clear and consistent reasons for the model score across households.

Successful applications of AI are due to improved systems, methods, algorithms, vast computing power, and massive amounts of data. AI systems have impressive capabilities resulting in tremendous opportunities for businesses and other institutions.

Although we as a society have benefited from this scientific progress, there is concern that decisions using AI to solve major societal problems and progress human wellbeing and economic value should be perceived as fair and be aligned with human values relevant to the problems being addressed. Trust is an essential component to modern economies which rely on the exchange of goods and ideas. The absence of trust in economies may lead to lower economic activity and has negative social repercussions.

Systems and methods enabled by this disclosure, along with the development of the field of XAI, is expected to lead to greater integrity, benevolence, and competency of AI systems and increase their predictive ability. If researchers are able to have transparency around the AI systems, then the systems will improve to become fairer according to human values and better across traditional machine learning metrics. Not only is XAI essential in critical systems which place human lives at risk such as aerospace, ground transportation, defense, and medicine, but it is imperative to all systems in order to improve the institutionalized trust we place on contemporary AI technology that determines our quality of life and economic stability.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A system for offering an explanation using a stochastic process in machine learning operations comprising:
a product limit estimator to analyze a data set and derive a nonparametric statistic indicative of a probability of occurrence of an in-class observation at a model score;
a hypothesis test to compare an efficacy of the product limit estimator operated with the data set using varied parameters;
a multiplicative hazards model for preparing the explanation for the model score relating to the in-class observation with regard to a baseline hazard rate at score intervals;
a generalized additive model to determine a causal relationship between covariates and coefficients dependent of the model score; and
wherein sequence, categorical data, and/or continuous data is regarded as inputs to an uninterpretable machine learning classification model.

2. The system of claim 1:
wherein the nonparametric statistic is used for estimating a cumulative probability of an observation being the in-class observation over a black box model score provided by a black box model.

3. The system of claim 2:
wherein the nonparametric statistic is approximately identical to a recall curve of the black box model.

4. The system of claim 1, further comprising:
point censoring to assist the product limit estimator without introducing bias by providing monitoring of the model score over a score set comprising missing event data.

5. The system of claim 1:
wherein the hypothesis test uses a semi-parametric model to compare the probability of inclusion derived from a black box model score provided by a black box model with the black box model score.

6. The system of claim 5:
wherein a hazard rate of the in-class observations is included by the explanation via the multiplicative hazards model.

7. The system of claim 5:
wherein comparison of the in-class observations with the black box model score relates to features used to train the black box model; and
wherein the multiplicative hazards model comprises a proportional hazards regression model.

8. The system of claim 1:
wherein the uninterpretable machine learning classification model comprises a recurrent neural network.

9. The system of claim 8:
wherein at least part of the machine learning operations incorporates time dependent data; and
wherein the recurrent neural network comprises a long short-term memory network comprising nonlinear deep connected layers that are at least partially uninterpretable.

10. The system of claim 8:
wherein the proportional hazards regression model analyzes input variables via a Markov model.

11. The system of claim 10:
wherein the Markov model is trained after the uninterpretable machine learning classification model to provide weights that assist in interpreting an output of the recurrent neural network.

12. The system of claim 1:
wherein the hypothesis test comprises a logrank hypothesis test.

13. The system of claim 1:
wherein the covariates analyzed by the generalized additive model are time variable covariates; and
wherein the baseline hazard rate is additionally compared to the coefficients.

14. A system for offering an explanation using a stochastic process in machine learning operations comprising:
a product limit estimator to analyze a data set and derive a nonparametric statistic used for estimating a cumulative probability of an observation being an in-class observation over a black box model score provided by a black box model;
a hypothesis test to compare an efficacy of the product limit estimator operated with the data set using varied parameters;
a proportional hazards regression model for preparing the explanation for the model score relating to the in-class observation with regard to a baseline hazard rate at score intervals;
a generalized additive model to determine a causal relationship between covariates and coefficients dependent of the model score;
point censoring to assist the product limit estimator without introducing bias by providing monitoring of the model score over a score set comprising missing event data;
wherein sequence data is regarded as inputs to an uninterpretable machine learning classification model;
wherein at least part of the data set is ordered via the stochastic process; and
wherein comparison of the in-class observations with the black box model score relates to features used to train the black box model.

15. The system of claim 14:
wherein the uninterpretable machine learning classification model comprises is a time dependent machine learning classification model comprising nonlinear deep connected layers that are at least partially uninterpretable.

16. The system of claim 14:
wherein the proportional hazards regression model analyzes input variables via a Markov model trained after the uninterpretable machine learning classification model to provide weights that assist in interpreting an output of the uninterpretable machine learning classification model.

17. A method of offering an explanation using a stochastic process in machine learning operations, the method being performed on a computerized device comprising a processor and memory with instructions being stored in the memory and operated from the memory to transform data, the method comprising:
(a) analyzing a data set via a product limit estimator;
(b) deriving a nonparametric statistic via the product limit estimator indicative of a probability of occurrence of an in-class observation at a model score;
(c) comparing via a hypothesis test an efficacy of the product limit estimator operated with the data set using varied parameters;
(d) preparing via a multiplicative hazards model the explanation for the model score relating to the in-class observation with regard to a baseline hazard rate at score intervals;
(e) determining via a generalized additive model a causal relationship between covariates and coefficients dependent of the model score; and
wherein sequence data, categorical data, and/or continuous data is regarded as inputs to an uninterpretable machine learning classification model.

18. The method of claim 17, further comprising:
(f) assisting the product limit estimator via point censoring by providing monitoring of the model score over a score set comprising missing event data without introducing bias.

19. The method of claim 18, further comprising:
(g) analyzing input variables via the multiplicative hazards model using a Markov model trained after operating the uninterpretable machine learning classification model to provide weights that assist in interpreting an output of the uninterpretable machine learning classification model.

20. The method of claim 17:
wherein the nonparametric statistic is used for estimating a cumulative probability of an observation being the in-class observation over a black box model score provided by a black box model that is approximately identical to a recall curve of the black box model.
